(19) United States
(12) Patent Application Publication
(10) Pub. No.: US 2025/0208460 A1
(43) Pub. Date: Jun. 26, 2025

(54) DISPLAY DEVICE

(71) Applicant: Sharp Display Technology Corporation, Kameyama City (JP)

(72) Inventor: Junichi MORINAGA, Kameyama City (JP)

(21) Appl. No.: 18/960,130

(22) Filed: Nov. 26, 2024

(30) Foreign Application Priority Data
Dec. 25, 2023 (JP) 2023-217981

(51) Int. Cl. G02F 1/1335; G02F 1/1333; G02F 1/1337; G02F 1/1339; G02F 1/1343; G02F 1/1347

(52) U.S. Cl. CPC G02F 1/133512; G02F 1/133388; G02F 1/133784; G02F 1/1339; G02F 1/134309; G02F 1/1347

(57) ABSTRACT

A display device includes a first liquid crystal panel and a second liquid crystal panel provided to oppose the first liquid crystal panel. The first liquid crystal panel includes a plurality of pixel electrodes disposed in a matrix shape along a first direction and a second direction intersecting with the first direction in a plan view, and a black matrix extended in the first direction and the second direction and provided with a plurality of openings that overlap the plurality of pixel electrodes. The second liquid crystal panel sequentially includes a first substrate, a spacer overlapping a display region in the plan view, an alignment film having been subjected to alignment treatment in a third direction different from the first and second directions in the plan view, a liquid crystal layer, and a second substrate. The spacer overlaps the black matrix in the plan view.

### CROSS-REFERENCE TO RELATED APPLICATIONS

This application claims the benefit of priority to Japanese Patent Application Number 2023-217981 filed on Dec. 25, 2023. The entire contents of the above-identified application are hereby incorporated by reference.

### BACKGROUND

### Technical Field

The disclosure relates to a display device.

As a technology related to display devices, for example, JP 2020-64092 A discloses a stereoscopic display device including a display panel and a barrier panel overlaid on the display panel. The display panel includes a BM region that does not emit display light and a plurality of pixels that serve as openings of the BM region and emit display light. The plurality of pixels are arrayed at equal pitches in an x-direction and a y-direction. A light barrier element includes a pair of glass substrates, a liquid crystal layer provided between the glass substrates, and a plurality of PSs provided between the glass substrates. The plurality of PSs are arrayed at equal pitches in the x-direction and the y-direction, and the array pitches of the plurality of PSs in the x-direction and the y-direction are respectively not an integer multiple of the array pitches of the plurality of pixels in the x-direction and the y-direction.

JP 2018-004872 A discloses a display device in which a pixel section as a display region for displaying an image and a frame section as a non-display region surrounding the pixel section are defined, and that includes a first display panel. The first display panel includes a first substrate, a second substrate disposed opposing the first substrate and including a light blocking layer, and a plurality of spacers formed between the first substrate and the second substrate. In the second substrate, a first frame area forming a portion disposed in the frame section includes a light blocking layer formation region formed with the light blocking layer and a light blocking layer non-formation region formed with no light blocking layer. Of the plurality of spaces, the spacer disposed in the frame section is formed on the light blocking layer formation region in the first frame area of the second substrate, and the light blocking layer non-formation region is disposed around the spacer disposed on the light blocking formation region.

JP 2020-139992 A discloses a liquid crystal display device including a first liquid crystal display panel and a second liquid crystal display panel opposing the first liquid crystal display panel. Each of the first liquid crystal display panel and the second liquid crystal display panel includes image signal lines, scanning lines, transistors provided in respective pixels, and pixel electrodes provided in respective pixels. At least one of the image signal line, the scanning line, a semiconductor layer of the transistor, and the pixel electrode is patterned in the same shape in the first liquid crystal display panel and the second liquid crystal display panel.

JP 2021-167890 A discloses an image display device including a display panel for displaying a composite image of a first image and a second image, and a barrier panel disposed being superposed on the display panel. The barrier panel includes a first barrier substrate, a second barrier substrate opposing the first barrier substrate with a liquid crystal layer interposed therebetween, spacers regularly arranged on a surface of the first barrier substrate opposing the second barrier substrate to maintain a constant distance between the first barrier substrate and the second barrier substrate, and a light blocking pattern irregularly arranged on the opposing surface of the first barrier substrate or the second barrier substrate. The spacers include a spacer shielded from light by overlapping the light blocking pattern in a plan view.

JP 2023-104136 A discloses an optical element that includes a first liquid crystal cell and a second liquid crystal cell, and does not include a polarizer between the first liquid crystal cell and the second liquid crystal cell. The first liquid crystal cell includes a first liquid crystal layer containing first liquid crystal molecules, and a first pair of electrodes for applying a voltage to the first liquid crystal layer. The second liquid crystal layer includes a second liquid crystal layer containing second liquid crystal molecules, and a second pair of electrodes for applying a voltage to the second liquid crystal layer. In a state where a voltage is not applied to any of the first liquid crystal layer and the second liquid crystal layer, an alignment direction of the first liquid crystal molecules in the first liquid crystal layer on the second liquid crystal cell side is parallel to an alignment direction of the second liquid crystal molecules in the second liquid crystal layer on the first liquid crystal cell side in a plan view.

### SUMMARY

An object of the disclosure is to provide a display device in which a decrease in display quality can be suppressed.

(1) According to an embodiment of the disclosure, a display device includes a display region in which an image is displayed and a frame region provided around the display region, and includes a first liquid crystal panel and a second liquid crystal panel provided to oppose the first liquid crystal panel. The first liquid crystal panel includes a plurality of pixel electrodes disposed in a matrix shape along a first direction and a second direction intersecting with the first direction in a plan view, and a black matrix extended in the first direction and the second direction and provided with a plurality of openings that overlap the plurality of pixel electrodes. The second liquid crystal panel sequentially includes a first substrate, a spacer overlapping the display region in the plan view, an alignment film having been subjected to alignment treatment in a third direction different from the first and second directions in the plan view, a liquid crystal layer, and a second substrate. The spacer overlaps the black matrix in the plan view.

(2) The display device according to a certain embodiment of the disclosure is as follows: in addition to having the configuration of (1) described above, the plurality of openings include a first opening, a second opening, a third opening, and a fourth opening arranged in a matrix shape; the black matrix includes a first region located at a center of the first opening, the second opening, the third opening, and the fourth opening; and the first region includes a first extending section extending in the first direction, a second extending section extending from the first extending section toward one side and the other side in the second direction, and a center portion located at an intersection point between a center line of the first extending section and a center line of the second extending section.

(3) The display device according to a certain embodiment of the disclosure is as follows: in addition to having the configuration of (2) described above, the alignment film has been subjected to rubbing treatment from one side toward the other side in the third direction, and the spacer is disposed inside the first extending section of the first region and on the one side in the third direction relative to the center portion of the first region in a plan view.

(4) The display device according to a certain embodiment of the disclosure is as follows: in addition to having the configuration of (3) described above, the first opening is located on the one side in the third direction relative to the center portion of the first region; the third opening is located on the other side in the third direction relative to the center portion of the first region; the first and second openings are adjacent to each other along the first direction; the third and fourth openings are adjacent to each other along the first direction; the first region includes a first intersection region in which the first and second extending sections intersect each other and that is surrounded by the first, second, third, and fourth openings; and the first intersection region includes a widened width portion of the black matrix widened toward the other side in the third direction in a region adjacent to a corner of the third opening in such a manner that a length from the center portion of the first region to the corner of the third opening adjacent to the first intersection region is longer than a length from the center portion of the first region to a corner of the second opening adjacent to the first intersection region.

(5) The display device according to a certain embodiment of the disclosure is as follows: in addition to having the configuration of (3) or (4) described above, the first opening is located on the one side in the third direction relative to the center portion of the first region; the third opening is located on the other side in the third direction relative to the center portion of the first region; the first and second openings are adjacent to each other along the first direction; the third and fourth openings are adjacent to each other along the first direction; the first region includes a first intersection region in which the first and second extending sections intersect each other and that is surrounded by the first, second, third, and fourth openings; and a corner of the fourth opening adjacent to the first intersection region linearly extends along the third direction from the one side toward the other side.

(6) The display device according to a certain embodiment of the disclosure is as follows: in addition to having the configuration of (2), (3), (4), or (5) described above, the first liquid crystal panel further includes a first liquid crystal panel-side spacer overlapping the first extending section of the first region in a plan view.

(7) The display device according to a certain embodiment of the disclosure is as follows: in addition to having the configuration of (2), (3), (4), (5), or (6) described above, the plurality of openings further include a fifth opening, a sixth opening, a seventh opening, and an eighth opening arranged in a matrix shape; the black matrix further includes a second region different from the first region located at a center of the fifth opening, the sixth opening, the seventh opening, and the eighth opening; the second region includes a first extending section extending in the first direction, a second extending section extending from the first extending section toward the one side and the other side in the second direction, and a center portion located at an intersection point between a center line of the first extending section and a center line of the second extending section, the spacer overlaps at least one of the first region and the second region in a plan view, and the first liquid crystal panel further includes a first liquid crystal panel-side spacer overlapping at least one of the first region and the second region in the plan view.

(8) The display device according to a certain embodiment of the disclosure is as follows: in addition to having the configuration of (7) described above, the alignment film has been subjected to rubbing treatment from the one side toward the other side in the third direction; the spacer does not overlap the first region but overlaps the second region in a plan view, and is disposed on the one side in the third direction relative to the center portion of the second region; and the first liquid crystal panel-side spacer overlaps the first extending section of the first region but does not overlap the second region in the plan view.

(9) The display device according to a certain embodiment of the disclosure is as follows: in addition to having the configuration of (8) described above, the fifth opening is located on the one side in the third direction relative to the center portion of the second region; the seventh opening is located on the other side in the third direction relative to the center portion of the second region; the fifth and sixth openings are adjacent to each other along the first direction; the seventh and eighth openings are adjacent to each other along the first direction; the second region includes a second intersection region in which the first and second extending sections of the second region intersect each other and that is surrounded by the fifth, sixth, seventh, and eighth openings; and the second intersection region includes a widened width portion of the black matrix widened toward the other side in the third direction in a region adjacent to a corner of the seventh opening in such a manner that a length from the center portion of the second region to the corner of the seventh opening adjacent to the second intersection region is longer than a length from the center portion of the second region to a corner of the sixth opening adjacent to the second intersection region.

(10) The display device according to a certain embodiment of the disclosure is as follows: in addition to having the configuration of (8) or (9) described above, the fifth opening is located on the one side in the third direction relative to the center portion of the second region; the seventh opening is located on the other side in the third direction relative to the center portion of the second region; the fifth and sixth openings are adjacent to each other along the first direction; the seventh and eighth openings are adjacent to each other along the first direction; the second region includes a second intersection region in which the first and second extending sections of the second region intersect each other and that is surrounded by the fifth, sixth, seventh, and eighth openings; and a corner of the eighth opening adjacent to the second intersection region linearly extends along the third direction from the one side toward the other side.

(11) The display device according to a certain embodiment of the disclosure is as follows: in addition to having the configuration of (1), (2), (3), (4), (5), (6), (7), (8), (9), or (10) described above, the second liquid crystal panel further includes a light blocking body overlapping at least part of the spacer in a plan view.

(12) The display device according to a certain embodiment of the disclosure is as follows: in addition to having the configuration of (11) described above, the alignment film has been subjected to rubbing treatment from the one side toward the other side in the third direction; the light blocking body has a longitudinal floating island shape in a plan view; a longitudinal direction of the light blocking body is parallel to the third direction in the plan view; and the spacer is disposed on the one side in the third direction relative to a center in the longitudinal direction of the light blocking body in the plan view.

(13) The display device according to a certain embodiment of the disclosure is as follows: in addition to having the configuration of (11) described above, the alignment film has been subjected to rubbing treatment from the one side toward the other side in the third direction; the light blocking body has a longitudinal floating island shape in a plan view; a longitudinal direction of the light blocking body is parallel to the third direction in the plan view; and the spacer overlaps a center in the longitudinal direction of the light blocking body in the plan view.

(14) The display device according to a certain embodiment of the disclosure is as follows: in addition to having the configuration of (11) described above, the light blocking body has a circular floating island shape in a plan view, and the spacer is disposed at a center of the light blocking body in the plan view.

(15) The display device according to a certain embodiment of the disclosure is as follows: in addition to having the configuration of (1), (2), (3), (4), (5), (6), (7), (8), (9), (10), (11), (12), (13), or (14) described above, the second liquid crystal panel includes a plurality of the spacers, and at least one of (A) and (B) given below is satisfied.

(A) A pitch of the plurality of spacers in the first direction is an integer multiple of a pitch of the plurality of pixel electrodes in the first direction.

(B) A pitch of the plurality of spacers in the second direction is an integer multiple of a pitch of the plurality of pixel electrodes in the second direction.

According to the disclosure, a display device capable of suppressing a decrease in display quality can be provided.

### BRIEF DESCRIPTION OF DRAWINGS

The disclosure will be described with reference to the accompanying drawings, wherein like numbers reference like elements.

FIG. 1 is a schematic cross-sectional view of a display device according to a first embodiment.

FIG. 2 is a schematic plan view of a display device according to the first embodiment.

FIG. 3 is an enlarged schematic cross-sectional view of a display device according to the first embodiment in a display region taken along a line A1-A2 in FIG. 2.

FIG. 4 is a schematic plan view of a first liquid crystal panel included in a display device according to the first embodiment.

FIG. 5 is a schematic plan view of a black matrix and a spacer of a first liquid crystal panel included in a display device according to the first embodiment.

FIG. 6 is a schematic plan view of a second liquid crystal panel included in a display device according to the first embodiment.

FIG. 7 is a schematic cross-sectional view of a second liquid crystal panel included in a display device according to the first embodiment.

FIG. 8 is a schematic plan view regarding a first substrate of a second liquid crystal panel included in a display device according to the first embodiment.

FIG. 9 is a schematic plan view regarding a second substrate of a second liquid crystal panel included in a display device according to the first embodiment.

FIG. 10 is an example of a schematic plan view of a display device according to a first modified example of the first embodiment.

FIG. 11 is an example of a schematic plan view of a first liquid crystal panel included in a display device according to the first modified example of the first embodiment.

FIG. 12 is a schematic plan view of a display device according to a second modified example of the first embodiment.

FIG. 13 is an example of a schematic plan view of a first liquid crystal panel included in a display device according to the second modified example of the first embodiment.

FIG. 14 is a schematic plan view of a display device according to a second embodiment.

FIG. 15 is a schematic plan view illustrating an example of a first liquid crystal panel included in a display device according to the second embodiment.

FIG. 16 is a schematic plan view illustrating an example of a first liquid crystal panel included in a display device according to the second embodiment.

FIG. 17 is a schematic plan view of a display device according to a third embodiment.

FIG. 18 is a schematic cross-sectional view of a display device according to a fourth embodiment.

FIG. 19 is a schematic plan view illustrating an example of a light blocking body and a spacer included in a second liquid crystal panel according to a display device of the fourth embodiment.

FIG. 20 is a schematic plan view illustrating an example of a light blocking body and a spacer included in a second liquid crystal panel according to a display device of the fourth embodiment.

FIG. 21 is a schematic plan view illustrating an example of a light blocking body and a spacer included in a second liquid crystal panel according to a display device of the fourth embodiment.

### DESCRIPTION OF EMBODIMENTS

Embodiments according to the disclosure will be described hereinafter. The technology according to the disclosure is not limited to the contents described in the following embodiments, and appropriate design changes can be made within a scope that satisfies the configuration according to the disclosure. In the description below, the same reference signs are appropriately used in common among the different drawings for the same parts or parts having similar functions, and repeated description thereof will be omitted as appropriate. The aspects of the disclosure may be combined as appropriate within a range that does not depart from the gist of the disclosure.

### First Embodiment

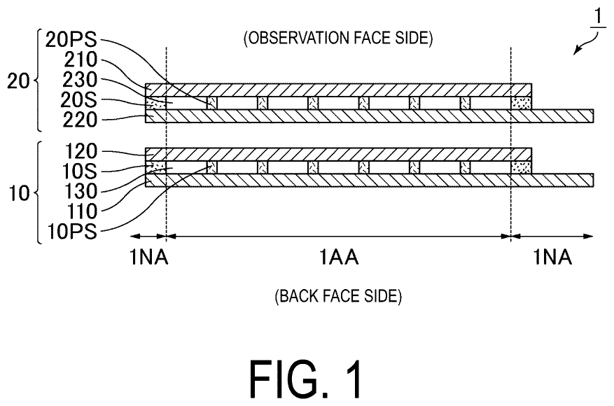

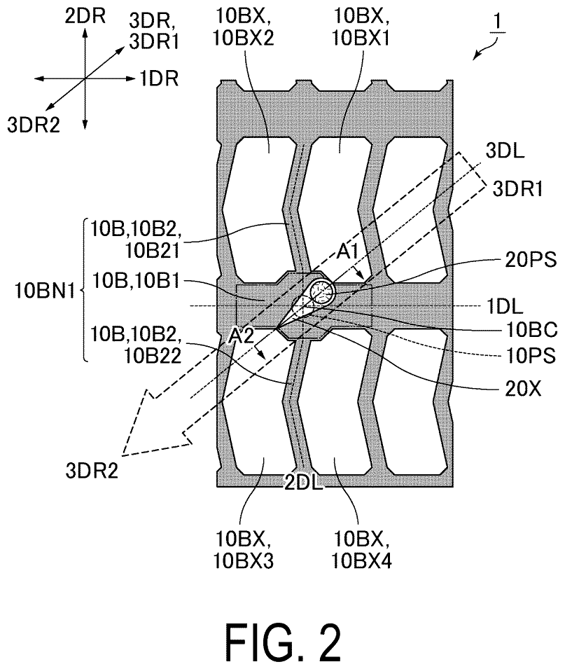

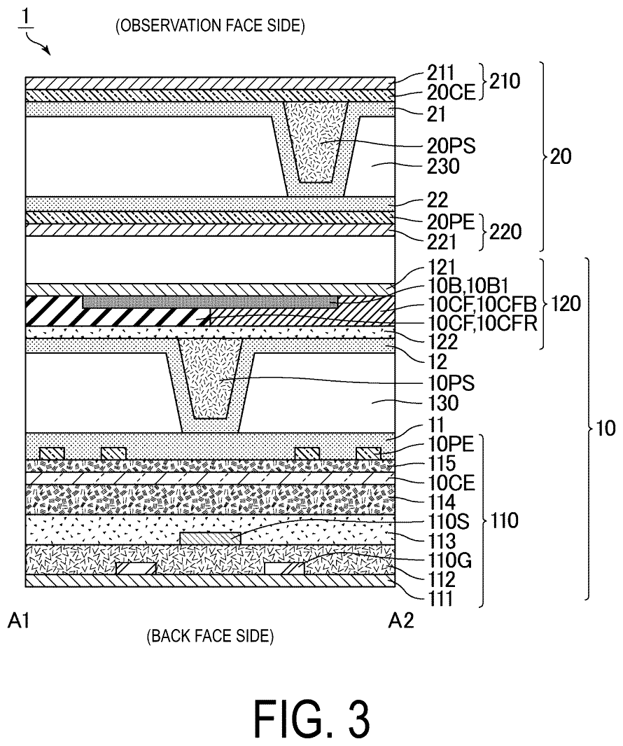

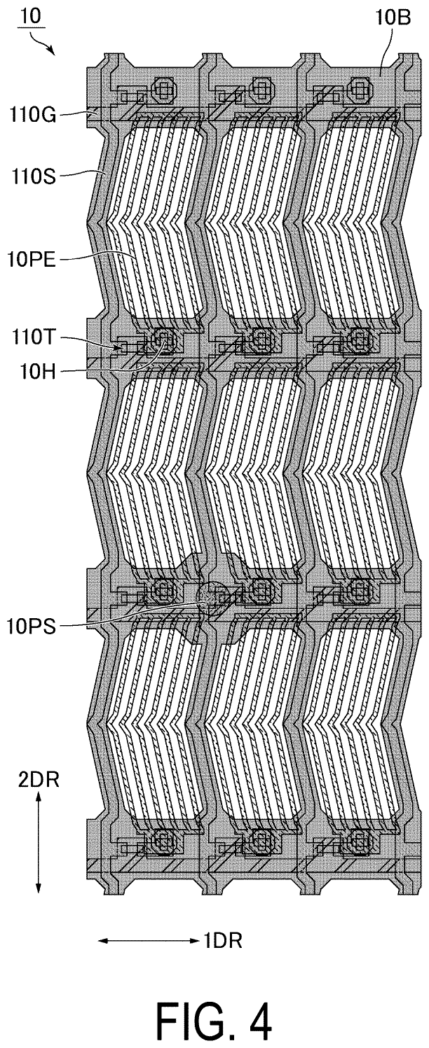

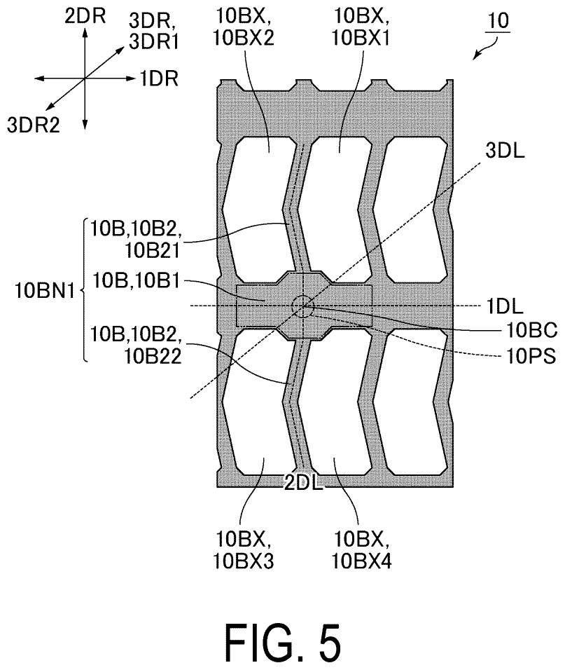

FIG. 1 is a schematic cross-sectional view of a display device according to a first embodiment. FIG. 2 is a schematic plan view of a display device according to the first embodiment. FIG. 3 is an enlarged schematic cross-sectional view of a display device according to the first embodiment in a display region taken along a line A1-A2 in FIG. 2. FIG. 4 is a schematic plan view of a first liquid crystal panel included in a display device according to the first embodiment. FIG. 5 is a schematic plan view of a black matrix and a spacer of a first liquid crystal panel included in a display device according to the first embodiment.

As illustrated in FIG. 1 to FIG. 5, a display device 1 of the present embodiment has a display region 1AA, in which an image is displayed, and a frame region 1NA provided around the display region 1AA, and includes a first liquid crystal panel 10 and a second liquid crystal panel 20 disposed to oppose the first liquid crystal panel 10. The first liquid crystal panel 10 includes a plurality of pixel electrodes 10PE arranged in a matrix shape along a first direction 1DR and a second direction 2DR intersecting with the first direction 1DR in a plan view, and a black matrix 10B extending in the first direction 1DR and the second direction 2DR and provided with a plurality of openings 10BX overlapping with the plurality of pixel electrodes 10PE. The second liquid crystal panel 20 includes a first substrate 210, a spacer 20PS (also referred to as a second liquid crystal panel-side spacer 20PS) overlapping the display region 1AA in the plan view, an alignment film 21 (also referred to as a first substrate-side alignment film 21) having been subjected to alignment treatment in a third direction 3DR different from the first direction 1DR and the second direction 2DR in the plan view, a liquid crystal layer 230 (also referred to as a second liquid crystal panel-side liquid crystal layer 230), and a second substrate 220 in sequence. The spacer 20PS overlaps the black matrix 10B in the plan view. With the above-discussed aspect, the black matrix 10B included in the first liquid crystal panel 10 can shield, from light, a region where liquid crystal alignment is disordered (alignment defect region 20X) in the second liquid crystal panel 20, thereby making it unnecessary to provide a light blocking body (also referred to as a light blocking layer) in the second liquid crystal panel 20. As a result, it is possible to suppress the degradation in display quality while suppressing a reduction in transmittance (aperture ratio) and a variation in thickness of the second liquid crystal panel 20. The first liquid crystal panel 10 is also referred to as a main liquid crystal panel 10. The second liquid crystal panel 20 is also referred to as a sub-liquid crystal panel 20.

As illustrated in FIG. 4, a gate line 110G, a source line 110S, the pixel electrode 10PE, a thin film transistor (TFT) 110T, a contact hole 10H, a spacer 10PS, and the like are disposed in the pixel of the main liquid crystal panel 10; then, by disposing the black matrix 10B in a necessary light blocking region, it is possible to secure preferred quality as the main liquid crystal panel.

The sub-liquid crystal panel 20 configured to impart functions such as 3D display and viewing angle control to the main liquid crystal panel 10 may have a simpler configuration than the main liquid crystal panel 10. The sub-liquid crystal panel 20 includes, for example, transparent electrodes formed on a pair of substrates, a liquid crystal material sealed between the pair of substrates, and a spacer for holding the cell thickness.

The alignment film 21 of the sub-liquid crystal panel 20 is subjected to alignment treatment for defining the direction of the initial alignment of the liquid crystal molecules contained in the liquid crystal layer 230 (the direction of the major axis of the liquid crystal molecules in a voltage non-applied state). An alignment defect is likely to occur in the periphery of the spacer, and a distinguishing alignment defect region may be generated particularly due to the influence of the rubbing treatment on the spacer to become a protrusion. In a case where the alignment defect region is not appropriately shielded from light, for example, the alignment defect region may be visually recognized as a light leakage region and may cause the degradation in display quality such as gray scale shift, contrast reduction, or display unevenness. In the present embodiment, when the main liquid crystal panel 10 and the sub-liquid crystal panel 20 are integrated with each other, the alignment defect region in the sub-liquid crystal panel 20 can be shielded from light by the light blocking body (black matrix 10B) of the main liquid crystal panel 10.

In a case where the main liquid crystal panel 10 for displaying an image is disposed at an observation face side of the sub-liquid crystal panel 20, the sub-liquid crystal panel 20 is preferably an active matrix type liquid crystal panel provided with no color filter. With the above-described aspect, the contrast of the display device 1 can be improved.

As illustrated in FIGS. 1 and 3, in a case where the main liquid crystal panel 10 for displaying an image is disposed at a back face side of the sub-liquid crystal panel 20, the sub-liquid crystal panel 20 preferably includes a pair of transparent electrodes having a fixed pattern capable of controlling only liquid crystal alignment of a specific planar shape in the display region 1AA (or a solid pattern capable of collectively controlling liquid crystal alignment of the entire display region 1AA), and a liquid crystal layer sandwiched between the pair of transparent electrodes. With the above aspect, a viewing angle control function, a 3D function, and the like can be imparted to the display device 1.

In the display device 1, for example, images for the left eye and the right eye are alternately displayed on the main liquid crystal panel 10 by a time division method, polarized states of the images for the left eye and the right eye are controlled on the sub-liquid crystal panel 20, and the images for the left eye and the right eye can be separately viewed using polarizing glasses. With this aspect, 3D display can be obtained. The sub-liquid crystal panel 20 in the display device 1 discussed above is also referred to as an active retarder.

In this case, a spacer is used to control the cell thickness of the liquid crystal layer. In a display device obtained by providing a light blocking body for shielding, from light, a liquid crystal alignment defect region of a spacer disposing portion in each of a main liquid crystal panel provided with a spacer and a sub-liquid crystal panel provided with a spacer and by bonding the main liquid crystal panel and the sub-liquid crystal panel, there arise problems such as a decrease in transmittance and an increase in manufacture man-hours for forming the light blocking bodies.

Specifically, since the spacer formed for controlling the cell thickness is a convex-shaped structure protruding toward the opposing substrate, it is difficult to uniformly apply an alignment film near the spacer. In addition, when rubbing treatment is performed on the alignment film, an alignment defect may occur in an incomplete push-in region. Although the degradation in display quality can be suppressed by completely shielding a target portion from light with a light blocking body such as a black matrix, the aperture ratio is lowered.

The sub-liquid crystal panel is not provided with, for example, a switching element such as a TFT in some cases. Even in such cases, at least one metal layer used for terminals and wiring lines for applying signals to the transparent electrodes, marks, and the like is disposed. It is conceivable to use the above metal layer as a light blocking body of the spacer. However, in this case, although there is no increase in the number of manufacturing steps, there are problems such as a decrease in aperture ratio, the generation of glare due to the influence of reflection and scattering on the metal layer, and the generation of moire between the light blocking body and the pixel lattice of the main liquid crystal panel.

On the other hand, the spacer 20PS (preferably, the spacer 20PS and the alignment defect region 20X in the periphery of the spacer 20PS) included in the sub-liquid crystal panel 20 of the present embodiment overlaps the light blocking body (black matrix 10B) of the main liquid crystal panel 10 in a plan view. According to such an aspect, the degradation in display quality caused by the sub-liquid crystal panel 20 can be suppressed by the black matrix 10B included in the main liquid crystal panel 10, thereby making it possible to suppress the degradation in display quality of the display device 1.

In the present embodiment, a light blocking body of the spacer 20PS is not disposed in the sub-liquid crystal panel 20, and the alignment defect region 20X in the periphery of the spacer 20PS of the sub-liquid crystal panel 20 is shielded from light by the black matrix 10B of the main liquid crystal panel 10, thereby solving the above-described problems. Hereinafter, the display device of the present embodiment will be described in detail.

As illustrated in FIG. 1, the display device 1 of the present embodiment includes the first liquid crystal panel 10 and the second liquid crystal panel 20 in order from the back face side toward the observation face side, but may include the second liquid crystal panel 20 and the first liquid crystal panel 10 in order from the back face side toward the observation face side. The display device 1 has the display region 1AA, in which an image is displayed, and the frame region 1NA provided around the display region 1AA.

As illustrated in FIGS. 1 and 3, the first liquid crystal panel 10 includes an array substrate 110, an alignment film 11 (also referred to as an array substrate-side alignment film 11), a liquid crystal layer 130 (also referred to as a first liquid crystal panel-side liquid crystal layer 130), an alignment film 12 (also referred to as a counter substrate-side alignment film 12), the spacer 10PS (also referred to as the first liquid crystal panel-side spacer 10PS), and a counter substrate 120 in order. A sealing portion 10S is provided in the frame region 1NA of the first liquid crystal panel 10. In the present embodiment, the array substrate 110 and the counter substrate 120 are provided in order from the back face side toward the observation face side, but the counter substrate 120 and the array substrate 110 may be provided in order from the back face side toward the observation face side.

As illustrated in FIGS. 3 and 4, the array substrate 110 includes a support substrate 111, a plurality of gate lines 110G extending in the first direction 1DR, a gate insulating film 112, a plurality of source lines 110S extending along the second direction 2DR, a first interlayer insulating film 113, a flattening film 114, a common electrode 10CE, a second interlayer insulating film 115, and the plurality of pixel electrodes 10PE in this order toward the liquid crystal layer 130 side. Positions for disposition of the pixel electrode 10PE and the common electrode 10CE may be exchanged.

In the present embodiment, a case in which the first liquid crystal panel 10 is a fringe field switching (FFS) mode liquid crystal display panel including the planar common electrode 10CE disposed on a surface of the support substrate 111 on the liquid crystal layer 130 side, the second interlayer insulating film 115 covering the common electrode 10CE, and the pixel electrodes 10PE disposed on a surface of the second interlayer insulating film 115 on the liquid crystal layer 130 side and provided with slits is exemplified and explained, but the display mode of the first liquid crystal panel is not limited to the FFS mode. The first liquid crystal panel 10 may be, for example, a liquid crystal panel of an in-plane switching (IPS) mode, a liquid crystal panel of a vertical alignment (VA) mode, or a liquid crystal panel of a twisted nematic (TN) mode.

The TFT 110T is disposed as a switching element at an intersection point between each gate line 110G and each source line 110S. Each TFT 110T is a three-terminal switch connected to the corresponding source line 110S and gate line 110G among the plurality of source lines 110S and plurality of gate lines 110G, and including a gate electrode projecting from the corresponding gate line 110G (part of the gate line 110G), a source electrode projecting from the corresponding source line 110S (part of the source line 110S), a drain electrode connected to the corresponding pixel electrode 10PE among the plurality of pixel electrodes 10PE, and a thin film semiconductor layer. The source electrode and the drain electrode are provided in the same layer as the source line 110S, and the gate electrode is provided in the same layer as the gate line 110G.

Each pixel electrode 10PE is disposed in a region surrounded by two source lines 110S adjacent to each other and two gate lines 110G adjacent to each other. Each pixel electrode 10PE is set to a potential in accordance with a data signal supplied via the corresponding TFT 110T. Each pixel electrode 10PE is connected to the corresponding drain electrode through the contact hole 10H.

The common electrode 10CE is an electrode formed on substantially an entire surface except for a specific portion such as a connection portion between the pixel electrode 10PE and the drain electrode, regardless of boundaries of the pixels. The common electrode 10CE is supplied with a common signal kept at a constant value, and is kept at a constant potential.

The pixel electrode 10PE and the common electrode 10CE can be formed in the following manner: for example, a transparent conductive material such as indium tin oxide (ITO), indium zinc oxide (IZO), zinc oxide (ZnO) or tin oxide (SnO), or an alloy thereof is film-formed by a sputtering method or the like to have single or multiple layers, and thereafter patterning is performed thereon using a photolithographic method.

As illustrated in FIGS. 3 and 5, the counter substrate 120 includes a support substrate 121, the black matrix 10B, color filters 10CF, and a flattening film 122 in this order toward the liquid crystal layer 130 side. The color filters 10CF include, for example, a red color filter 10CFR, a blue color filter 10CFB, and a green color filter.

The black matrix 10B extends in the first direction 1DR and the second direction 2DR, and is provided with a plurality of openings 10BX overlapping the plurality of pixel electrodes 10PE. The material of the black matrix 10B is not particularly limited as long as it has a light blocking property, and a resin material containing a black pigment or a metal material having a light blocking property is suitably used. The black matrix 10B is formed by a photolithographic method in which, for example, a film is formed by applying a photosensitive resin containing a black pigment, and then exposure, development, and the like are performed.

As illustrated in FIGS. 2 and 5, the plurality of openings 10BX preferably include a first opening 10BX1, a second opening 10BX2, a third opening 10BX3, and a fourth opening 10BX4 arranged in a matrix shape. The black matrix 10B preferably includes a first region 10BN1 located at the center of the first opening 10BX1, the second opening 10BX2, the third opening 10BX3, and the fourth opening 10BX4. The first region 10BN1 preferably includes a first extending section 10B1 extending in the first direction 1DR, a second extending section 10B2 extending from the first extending section 10B1 toward one side and the other side in the second direction 2DR (a second extending section 10B21 extending toward one side and a second extending section 10B22 extending toward the other side), and a center portion 10BC located at an intersection point between a center line of the first extending section 10B1 and a center line of the second extending section 10B2.

In this case, the first extending section is only required to extend in the first direction as a whole, and may partially extend in a direction different from the first direction. For example, the first extending section may have a bent portion as long as the first extending section extends in the first direction as a whole. The second extending section is only required to extend in the second direction as a whole, and may partially extend in a direction different from the second direction. For example, the second extending section may have a bent portion as long as it extends in the second direction as a whole. The center line of the first extending section is a line connecting points that bisect the width of the first extending section. The center line of the second extending section is a line connecting points that bisect the width of the second extending section.

Each opening 10BX has a longitudinal shape, and the second direction 2DR is a direction along the longitudinal direction of each opening 10BX.

The first opening 10BX1 is located on one side 3DR1 in the third direction 3DR relative to the center portion 10BC of the first region 10BN1, and the third opening 10BX3 is located on the other side 3DR2 in the third direction 3DR relative to the center portion 10BC of the first region 10BN1. The first opening 10BX1 and the second opening 10BX2 are adjacent to each other along the first direction 1DR, and the third opening 10BX3 and the fourth opening 10BX4 are adjacent to each other along the first direction 1DR. The second opening 10BX2 and the third opening 10BX3 are adjacent to each other along the second direction 2DR, and the first opening 10BX1 and the fourth opening 10BX4 are adjacent to each other along the second direction 2DR.

The alignment films 11 and 12 have a function of controlling the alignment of the liquid crystal molecules in the liquid crystal layer 130, and when a voltage applied to the liquid crystal layer 130 is lower than a threshold voltage (including no voltage application), the alignment of the liquid crystal molecules in the liquid crystal layer 130 is controlled mainly by action of the alignment films 11 and 12. As materials for the alignment films 11 and 12, materials commonly used in the field of liquid crystal display panels can be used, such as polymers having polyimide in the main chain, polymers having polyamic acid in the main chain, and polymers having polysiloxane in the main chain.

The alignment films 11 and 12 can be formed by applying an alignment film material, and the coating method is not particularly limited. For example, flexographic printing, ink-jet coating, or the like can be used.

The alignment films 11 and 12 may be a horizontal alignment film in which liquid crystal molecules are substantially horizontally aligned with respect to the film plane, or may be a vertical alignment film in which liquid crystal molecules are substantially vertically aligned with respect to the film plane. The alignment films 11 and 12 may be a photo-alignment film having a photo-functional group and having been subjected to photo-alignment treatment as alignment treatment, may be a rubbing alignment film having been subjected to rubbing treatment as alignment treatment, or may be an alignment film not having been subjected to alignment treatment.

The liquid crystal layer 130 contains a liquid crystal material. Then, an amount of light to be transmitted is controlled by applying a voltage to the liquid crystal layer 130 to change an alignment state of the liquid crystal molecules in the liquid crystal material in accordance with the applied voltage. The liquid crystal molecules may have a positive or negative value of dielectric constant anisotropy (Δε) as defined by an equation (L) given below. Note that the liquid crystal molecules having positive anisotropy of dielectric constant is also referred to as positive-working liquid crystal, and the liquid crystal molecules having negative anisotropy of dielectric constant is also referred to as negative-working liquid crystal. A major axis direction of the liquid crystal molecules is a direction of a slow axis. The liquid crystal molecules take a homogeneous alignment in a state in which a voltage is not applied (voltage non-applied state), and the major axis direction of the liquid crystal molecules in the voltage non-applied state is also referred to as a direction of the initial alignment of the liquid crystal molecules.

Δε=(dielectric constant in major axis direction of liquid crystal molecules)−(dielectric constant in minor axis direction of liquid crystal molecules) (Equation L)

The spacer 10PS has a function to secure a gap for a space where the liquid crystal layer 130 is formed. The spacer 10PS is provided on the counter substrate 120. The tip of the spacer 10PS is in contact with the array substrate 110. The spacer 10PS is also referred to as a main spacer. The first liquid crystal panel 10 preferably includes a plurality of the spacers 10PS.

The spacer 10PS has, for example, a columnar shape. The planar shape of the spacer 10PS may be, for example, a polygonal shape, a circular shape, or an elliptical shape. It is preferable for the spacer 10PS to contain a cured product of a photosensitive resin, for example. Examples of the photosensitive resin include a resin having an ultraviolet reactive functional group.

As illustrated in FIGS. 2, 3, and 5, the first liquid crystal panel 10 preferably includes the first liquid crystal panel-side spacer 10PS overlapping the first extending section 10B1 of the first region 10BN1 in a plan view. With the above aspect, the alignment defect region in the periphery of the spacer 10PS can be effectively shielded from light, and a decrease in display quality can be effectively suppressed.

It is more preferable for the first liquid crystal panel-side spacer 10PS to overlap the center portion 10BC of the first region 10BN1 in a plan view. In the periphery of the center portion 10BC, the black matrix 10B has a planar shape extending in both the first direction 1DR and the second direction 2DR, and has a larger area than the other portions. Therefore, it is possible to more effectively shield the alignment defect region in the periphery of the spacer 10PS from light, and it is possible to more effectively suppress a decrease in display quality.

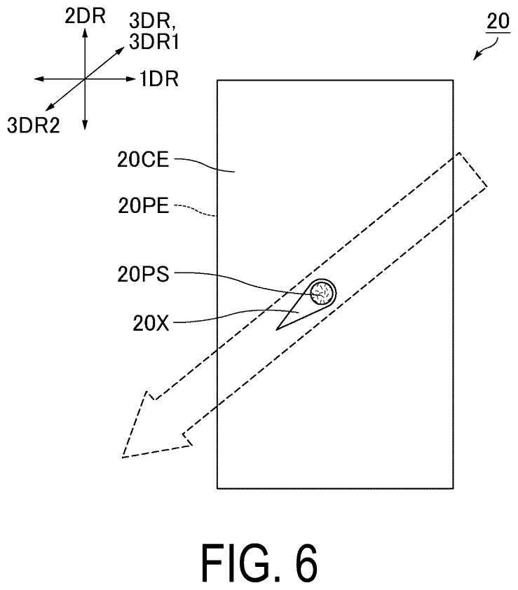

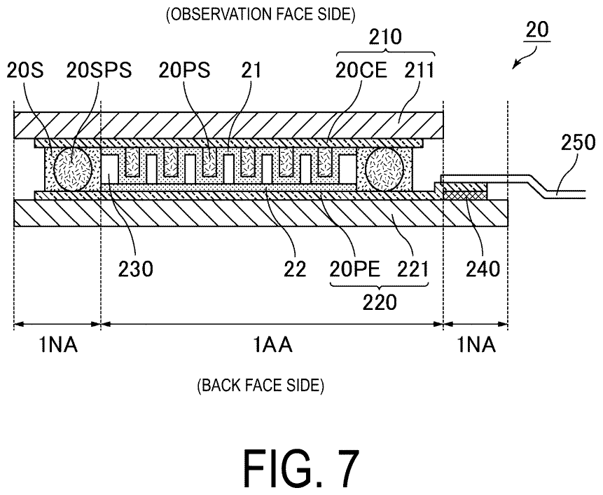

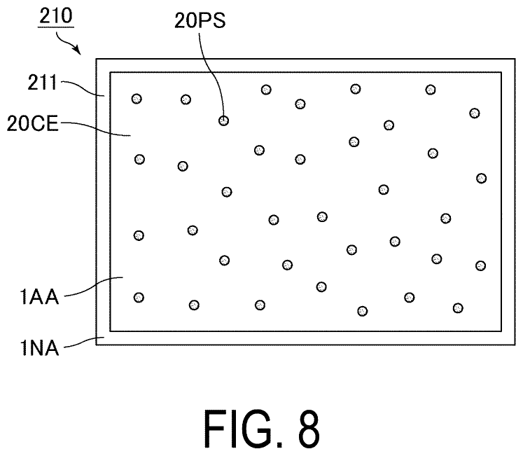

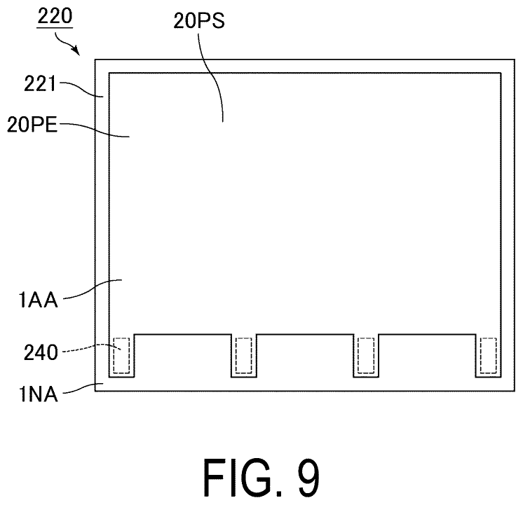

FIG. 6 is a schematic plan view of the second liquid crystal panel included in the display device according to the first embodiment. FIG. 7 is a schematic cross-sectional view of the second liquid crystal panel included in the display device according to the first embodiment. FIG. 8 is a schematic plan view regarding the first substrate of the second liquid crystal panel included in the display device according to the first embodiment, and FIG. 9 is a schematic plan view regarding the second substrate of the second liquid crystal panel included in the display device according to the first embodiment.

As illustrated in FIGS. 1 to 3 and 6 to 9, the second liquid crystal panel 20 includes the first substrate 210, the spacer 20PS, the alignment film 21 (also referred to as the first substrate-side alignment film 21), the liquid crystal layer 230, an alignment film 22 (also referred to as a second substrate-side alignment film 22), and the second substrate 220 in sequence. A sealing portion 20S is provided in the frame region 1NA of the second liquid crystal panel 20. The display device 1 according to the present embodiment includes the second substrate 220 and the first substrate 210 in order from the back face side toward the observation face side.

As illustrated in FIG. 3, the first substrate 210 includes a support substrate 211 and a first substrate-side electrode 20CE in order toward the liquid crystal layer 230 side. The second substrate 220 includes a support substrate 221 and a second substrate-side electrode 20PE in order toward the liquid crystal layer 230 side.

As illustrated in FIG. 6, the second liquid crystal panel 20 does not include any of a gate line, a source line, and a TFT. The first substrate-side electrode 20CE and the second substrate-side electrode 20PE are each provided in a planar shape in the display region 1AA. The second liquid crystal panel 20 does not have a configuration equivalent to the “pixel” in the first liquid crystal panel 10. The second liquid crystal panel 20 does not include a light blocking body such as a black matrix in the display region 1AA.

As illustrated in FIGS. 7 and 9, a terminal forming metal material 240 is provided in the frame region 1NA of the second substrate 220. The second substrate-side electrode 20PE extending from the display region 1AA to the frame region 1NA is electrically connected to the terminal forming metal material 240. The second substrate-side electrode 20PE is connected to a flexible printed circuit (FPC) substrate 250 in a region overlapping the terminal forming metal material 240 in a plan view. With this aspect, signals can be input to the second substrate-side electrode 20PE via the flexible printed circuit substrate 250. By changing the signals input to the second substrate-side electrode 20PE, the alignment of the liquid crystal molecules contained in the liquid crystal layer 230 can be changed. The second liquid crystal panel 20 is allowed not to include the terminal forming metal material 240. The second substrate-side electrode 20PE of the present embodiment functions as a segment electrode. Although the second substrate-side electrode 20PE of the present embodiment is one solid pattern corresponding to the entire display region 1AA, the second substrate-side electrode 20PE may be divided into a plurality of portions, and different signals may be respectively input to the plurality of the divided second substrate-side electrodes 20PE.

The second liquid crystal panel 20 includes an in-seal spacer 20SPS in a region overlapping the sealing portion 20S in a plan view. The second liquid crystal panel 20 includes gold particle beads in a region overlapping the sealing portion 20S in the plan view. With this aspect, signals can be input to the first substrate-side electrode 20CE via the flexible printed circuit substrate 250, the second substrate-side electrode 20PE, and the gold particle beads. The first substrate-side electrode 20CE of the present embodiment is maintained at a constant potential and functions as a common electrode.

The first substrate-side electrode 20CE and the second substrate-side electrode 20PE can be formed in the following manner: for example, a transparent conductive material such as indium tin oxide (ITO), indium zinc oxide (IZO), zinc oxide (ZnO) or tin oxide (SnO), or an alloy thereof is film-formed by a sputtering method or the like to have single or multiple layers, and thereafter patterning is performed thereon using a photolithographic method.

The alignment films 21 and 22 have a function of controlling the alignment of the liquid crystal molecules in the liquid crystal layer 230, and when a voltage applied to the liquid crystal layer 230 is lower than a threshold voltage (including no voltage application), the alignment of the liquid crystal molecules in the liquid crystal layer 230 is controlled mainly by action of the alignment films 21 and 22. As materials for the alignment films 21 and 22, materials commonly used in the field of liquid crystal display panels can be used, such as polymers having polyimide in the main chain, polymers having polyamic acid in the main chain, and polymers having polysiloxane in the main chain.

The alignment films 21 and 22 can be formed by applying an alignment film material, and the coating method is not particularly limited. For example, flexographic printing, ink-jet coating, or the like can be used.

The alignment films 21 and 22 may be a horizontal alignment film in which liquid crystal molecules are substantially horizontally aligned with respect to the film plane, or may be a vertical alignment film in which liquid crystal molecules are substantially vertically aligned with respect to the film plane.

The alignment film 22 may be a photo-alignment film having a photo-functional group and having been subjected to photo-alignment treatment as alignment treatment, may be a rubbing alignment film having been subjected to rubbing treatment as alignment treatment, or may be an alignment film not having been subjected to alignment treatment.

As illustrated in FIG. 2, the alignment film 21 is preferably a rubbing alignment film having been subjected to alignment treatment from the one side 3DR1 toward the other side 3DR2 in the third direction 3DR. It is difficult to uniformly perform rubbing treatment on the alignment film provided on the spacer, and thus an alignment defect is particularly likely to occur in the periphery of the spacer. However, in the present embodiment, even when the alignment film 21 is a rubbing alignment film, it is possible to effectively suppress a decrease in display quality. A broken line arrow depicted in FIG. 2 indicates a rubbing direction of the alignment film 21. The alignment direction of the liquid crystal molecules contained in the liquid crystal layer 230 is the same as the third direction 3DR.

The alignment film 21 has been subjected to alignment treatment in the third direction 3DR different from the first direction 1DR and the second direction 2DR in a plan view. In the plan view, an angle formed by the first direction 1DR and the second direction 2DR is, for example, 80° or more and 100° or less. In the plan view, an angle formed by the first direction 1DR and the third direction 3DR is, for example, 20° or more and 70° or less, or 110° or more and 160° or less. In the present embodiment, the angle formed by the first direction 1DR and the second direction 2DR is 90°, and the angle formed by the first direction 1DR and the third direction 3DR is 45°.

The liquid crystal layer 230 contains a liquid crystal material. Then, an amount of light to be transmitted is controlled by applying a voltage to the liquid crystal layer 230 to change an alignment state of the liquid crystal molecules in the liquid crystal material in accordance with the applied voltage. The liquid crystal molecules may be positive-working liquid crystal or negative-working liquid crystal.

The spacer 20PS has a function to secure a gap for a space where the liquid crystal layer 230 is formed. The spacer 20PS is provided on the first substrate 210, and the tip of the spacer 20PS may or may not be in contact with the second substrate 220, but it is preferable to be in contact with the second substrate 220. The second liquid crystal panel 20 preferably includes a plurality of the spacers 20PS.

The spacer 20PS has, for example, a columnar shape. The planar shape of the spacer 20PS may be, for example, a polygonal shape, a circular shape, or an elliptical shape. It is preferable for the spacer 20PS to contain a cured product of a photosensitive resin, for example. Examples of the photosensitive resin include a resin having an ultraviolet reactive functional group.

As illustrated in FIG. 2, the spacer 20PS overlaps the first region 10BN1 of the black matrix 10B in a plan view. The spacer 20PS preferably overlaps the first extending section 10B1 of the first region 10BN1 of the black matrix 10B in the plan view.

The alignment film 21 has been subjected to rubbing treatment from the one side 3DR1 toward the other side 3DR2 in the third direction 3DR, and the spacer 20PS is preferably disposed inside the first extending section 10B1 of the first region 10BN1 and on the one side 3DR1 in the third direction 3DR relative to the center portion 10BC of the first region 10BN1 in a plan view.

When rubbing treatment is performed on the alignment film provided on the spacer, the alignment treatment is more difficult to be performed on the downstream side (i.e., the other side 3DR2 in the third direction 3DR) than on the upstream side (i.e., the one side 3DR1 in the third direction 3DR) in the rubbing direction, and the alignment defect is more likely to occur. Because of this, when the spacer 20PS is disposed inside the first extending section 10B1 and on the one side 3DR1 in the third direction 3DR relative to the center portion 10BC of the first region 10BN1, it is possible to effectively block the light toward the alignment defect region 20X likely to be generated on the other side 3DR2 in the third direction 3DR (the downstream side in the rubbing direction), thereby making it possible to effectively suppress a decrease in display quality.

As described above, in the present embodiment, the position of the spacer 20PS of the second liquid crystal panel 20 is disposed being shifted from the center of the light blocking region (first extending section 10B1) of the black matrix 10B disposed in the periphery of the spacer 10PS of the first liquid crystal panel 10, whereby the alignment defect region 20X caused by the rubbing can be efficiently shielded from light.

The upstream side and the downstream side in the rubbing direction can be confirmed by observing the alignment defect region (light leakage region) on the second liquid crystal panel side with an optical microscope. In this case, it may be necessary to replace a polarizer, apply a voltage to the second liquid crystal panel, or the like. In the case where it is difficult to specify the rubbing direction by this method, the rubbing direction can be specified more directly by observing the surface of the alignment film (alignment film 21) on the second liquid crystal panel side and checking the sparseness and denseness of scratches (irregularities) due to rubbing in the periphery of the spacer (spacer 20PS) included in the second liquid crystal panel. Taking the spacer included in the second liquid crystal panel as a reference, rubbing scratches are less likely to occur on the downstream side in the rubbing direction than on the upstream side; therefore, taking the spacer included in the second liquid crystal panel as a reference, the side having more rubbing scratches can be specified as the upstream side in the rubbing direction, and the side having fewer rubbing scratches can be specified as the downstream side in the rubbing direction. AFM analysis, Os-SEM analysis, or the like may be used as a method for observing the surface of the alignment film.

It is preferable that the spacer 20PS be disposed in a region located on the one side 3DR1 in the third direction 3DR among two regions of the first extending section 10B1 of the first region 10BN1 divided by a second straight line 2DL in a plan view. With this aspect, the alignment defect region 20X likely to be generated on the other side 3DR2 (the downstream side in the rubbing direction) in the third direction 3DR can be effectively shielded from light, and a decrease in display quality can be effectively suppressed.

As illustrated in FIG. 2, the spacer 20PS preferably overlaps a third straight line 3DL passing through the center portion 10BC of the first region 10BN1 and being parallel to the third direction 3DR in a plan view. With the above aspect, the alignment defect region 20X likely to be generated on the other side 3DR2 (downstream side in the rubbing direction) in the third direction 3DR can be more effectively shielded from light, and a decrease in display quality can be more effectively suppressed.

In the case where the second liquid crystal panel 20 includes the plurality of spacers 20PS, it is preferable that at least one of (A) and (B) given below be satisfied.

(A) The pitch of the plurality of spacers 20PS in the first direction 1DR is an integer multiple of the pitch of the plurality of pixel electrodes 10PE in the first direction 1DR.

(B) The pitch of the plurality of spacers 20PS in the second direction 2DR is an integer multiple of the pitch of the plurality of pixel electrodes 10PE in the second direction 2DR.

The pitch of the plurality of spacers 20PS in the first direction 1DR is a distance between center portions of two spacers 20PS adjacent to each other along the first direction 1DR. The pitch of the plurality of pixel electrodes 10PE in the first direction 1DR is a distance between center portions of two pixel electrodes 10PE adjacent to each other along the first direction 1DR.

The pitch of the plurality of spacers 20PS in the first direction 1DR is preferably not less than one time and not more than 10 times as long as the pitch of the plurality of pixel electrodes 10PE in the first direction 1DR.

The pitch of the plurality of spacers 20PS in the second direction 2DR is a distance between the center portions of two spacers 20PS adjacent to each other along the second direction 2DR. The pitch of the plurality of pixel electrodes 10PE in the second direction 2DR is a distance between the center portions of two pixel electrodes 10PE adjacent to each other along the second direction 2DR.

The pitch of the plurality of spacers 20PS in the second direction 2DR is preferably not less than one time and not more than 10 times as long as the pitch of the plurality of pixel electrodes 10PE in the second direction 2DR.

The ratio of the pitch of the plurality of spacers 20PS in the first direction 1DR to the pitch of the plurality of pixel electrodes 10PE in the first direction 1DR may be equal to or different from the ratio of the pitch of the plurality of spacers 20PS in the second direction 2DR to the pitch of the plurality of pixel electrodes 10PE in the second direction 2DR.

### First Modified Example of First Embodiment

In order to effectively shield the alignment defect region 20X in the second liquid crystal panel 20 from light, it is preferable to deform the pattern of the black matrix 10B of the main liquid crystal panel 10. In the present modified example, an aspect in which the pattern of the black matrix 10B is deformed will be described.

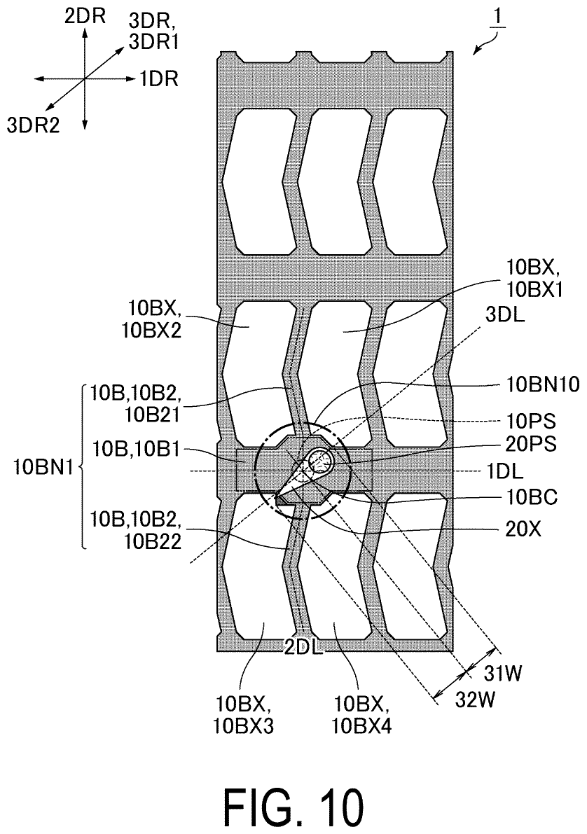

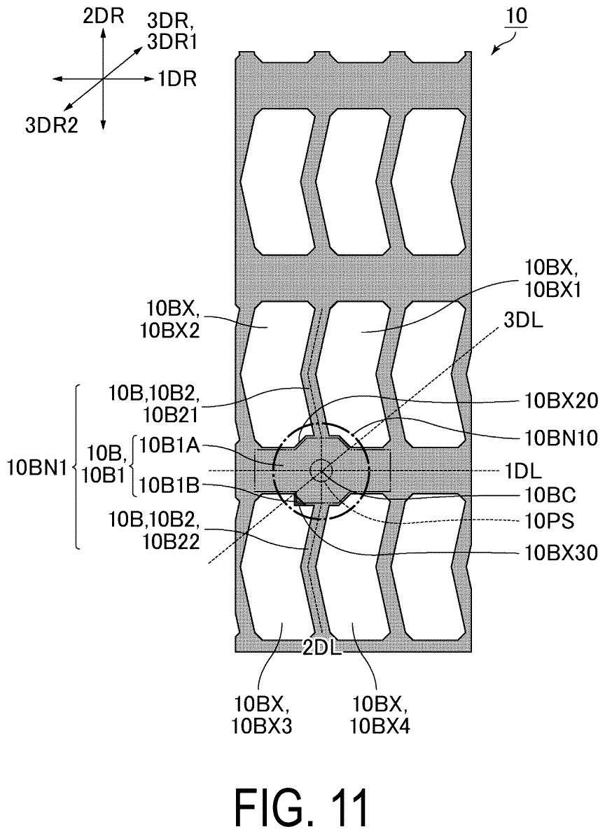

FIG. 10 is an example of a schematic plan view of a display device according to a first modified example of the first embodiment. FIG. 11 is an example of a schematic plan view of a first liquid crystal panel included in the display device according to the first modified example of the first embodiment. As illustrated in FIGS. 10 and 11, the spacer 20PS of the present modified example is disposed inside the first extending section 10B1 of the first region 10BN1 and on the one side 3DR1 in the third direction 3DR relative to the center portion 10BC of the first region 10BN1 in a plan view, as in the first embodiment. Further, the spacer 20PS overlaps the third straight line 3DL passing through the center portion 10BC of the first region 10BN1 and being parallel to the third direction 3DR in the plan view.

As illustrated in FIG. 10, on the third straight line 3DL, a width 32W of the black matrix 10B from the center portion 10BC of the first region 10BN1 toward the other side 3DR2 in the third direction 3DR is wider than a width 31W of the black matrix 10B from the center portion 10BC of the first region 10BN1 toward the one side 3DR1 in the third direction 3DR. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

As illustrated in FIG. 11, the first region 10BN1 preferably includes a first intersection region 10BN10 surrounded by the first opening 10BX1, the second opening 10BX2, the third opening 10BX3, and the fourth opening 10BX4, where the first extending section 10B1 and the second extending section 10B2 intersect with each other. The first intersection region 10BN10 preferably includes a widened width portion 10B1B of the black matrix widened toward the other side 3DR2 in the third direction 3DR in a region adjacent to a corner 10BX30 of the third opening 10BX3 in such a manner that a length from the center portion 10BC of the first region 10BN1 to the corner 10BX30 of the third opening 10BX3 adjacent to the first intersection region 10BN10 is longer than a length from the center portion 10BC of the first region 10BN1 to a corner 10BX20 of the second opening 10BX2 adjacent to the first intersection region 10BN10. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

As illustrated in FIG. 11, the first extending section 10B1 of the first region 10BN1 preferably includes a symmetrical portion 10B1A having a symmetrical shape with respect to a first straight line 1DL, and the widened width portion 10B1B widened relative to the symmetrical portion 10B1A in a region located on the other side 3DR2 in the third direction 3DR of the two regions of the first extending section 10B1 divided by the second straight line 2DL. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

As illustrated in FIG. 11, when the first opening 10BX1 is rotated about the center portion 10BC of the first region 10BN1 to overlap the third opening 10BX3 in a plan view, the shape of the corner of the third opening 10BX3 on the center portion 10BC side preferably matches a shape obtained by combining the shape of the corner of the first opening 10BX1 on the center portion 10BC side with the widened width portion 10B1B of the black matrix 10B disposed on the center portion 10BC side of the first region 10BN1 of the third opening 10BX3. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

In a plan view, the widened width portion 10B1B preferably overlaps the third straight line 3DL. By adopting such aspect, a decrease in display quality may be particularly effectively suppressed.

### Second Modified Example of First Embodiment

In order to effectively shield the alignment defect region 20X in the second liquid crystal panel 20 from light, it is preferable to deform the pattern of the black matrix 10B of the main liquid crystal panel 10. In the present modified example, an aspect in which the pattern of the black matrix 10B is deformed will be described.

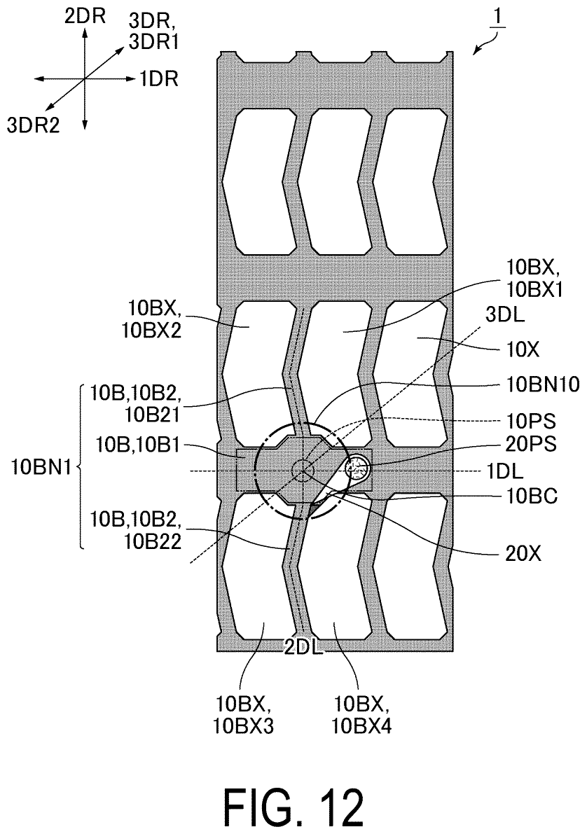

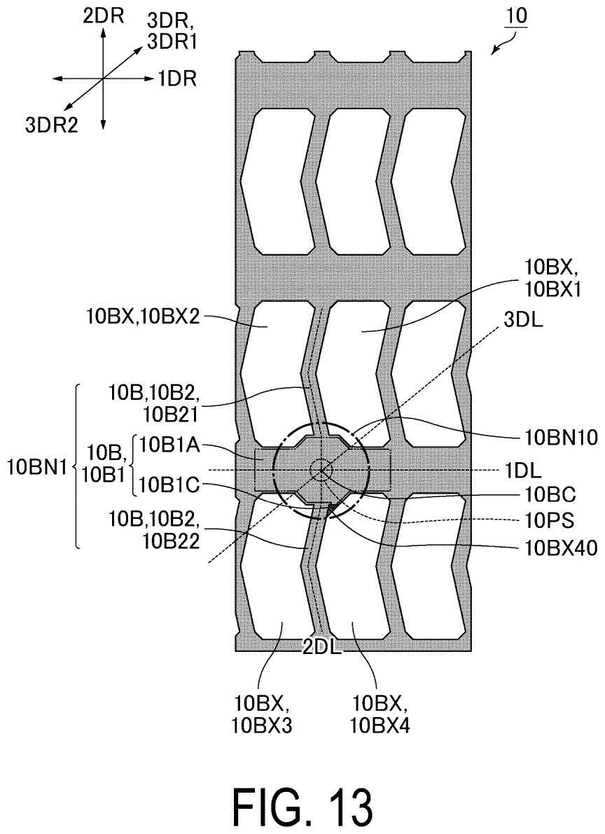

FIG. 12 is a schematic plan view of a display device according to a second modified example of the first embodiment. FIG. 13 is an example of a schematic plan view of a first liquid crystal panel included in the display device according to the second modified example of the first embodiment. As illustrated in FIGS. 12 and 13, the spacer 20PS of the present modified example is disposed inside the first extending section 10B1 of the first region 10BN1 and on the one side 3DR1 in the third direction 3DR relative to the center portion 10BC of the first region 10BN1 in a plan view, as in the first embodiment. Further, it is preferable for the spacer 20PS not to overlap the third straight line 3DL passing through the center portion 10BC of the first region 10BN1 and being parallel to the third direction 3DR in the plan view.

As illustrated in FIG. 13, the first region 10BN1 preferably includes the first intersection region 10BN10 surrounded by the first opening 10BX1, the second opening 10BX2, the third opening 10BX3, and the fourth opening 10BX4, where the first extending section 10B1 and the second extending section 10B2 intersect with each other. It is preferable that a corner 10BX40 of the fourth opening 10BX4 adjacent to the first intersection region 10BN10 linearly extend along the third direction 3DR from the one side 3DR1 toward the other side 3DR2. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

As illustrated in FIG. 13, the first extending section 10B1 of the first region 10BN1 preferably includes the symmetrical portion 10B1A having a symmetrical shape with respect to the first straight line 1DL, and a widened width portion 10B1C widened relative to the symmetrical portion 10B1A in a region located on the one side 3DR1 in the third direction 3DR of the two regions of the first extending section 10B1 divided by the second straight line 2DL. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

As illustrated in FIG. 13, when the second opening 10BX2 is rotated about the center portion 10BC of the first region 10BN1 to overlap the fourth opening 10BX4 in a plan view, the shape of the corner of the fourth opening 10BX4 on the center portion 10BC side preferably matches a shape obtained by combining the shape of the corner of the second opening 10BX2 on the center portion 10BC side with the widened width portion 10B1C of the black matrix 10B disposed on the center portion 10BC side of the first region 10BN1 of the fourth opening 10BX4. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

### Third Modified Example of First Embodiment

The second liquid crystal panel 20 of the present modified example includes a plurality of the spacers 20PS and a plurality of the first regions 10BN1. Each spacer 20PS overlaps with the corresponding first region 10BN1 in a plan view. The first intersection region 10BN10 included in some of the first regions 10BN1 includes the widened width portion 10B1B of the black matrix 10B widened toward the other side 3DR2 in the third direction 3DR in a region adjacent to the corner 10BX30 of the third opening 10BX3. The corner 10BX40 of the fourth opening 10BX4 adjacent to other first regions 10BN1 linearly extends along the third direction 3DR from the one side 3DR1 toward the other side 3DR2. As described above, the configuration of the first modified example of the first embodiment may be employed in a certain region in the display region 1AA, and the configuration of the second modified example of the first embodiment may be employed in another region.

### Second Embodiment

In the present embodiment, features unique to the present embodiment will be mainly described, and description of contents overlapping with those of the first embodiment and its modified examples will be omitted. The present embodiment is substantially the same as the first embodiment and its modified examples, except that the disposition of a first liquid crystal panel-side spacer 10PS is different therefrom.

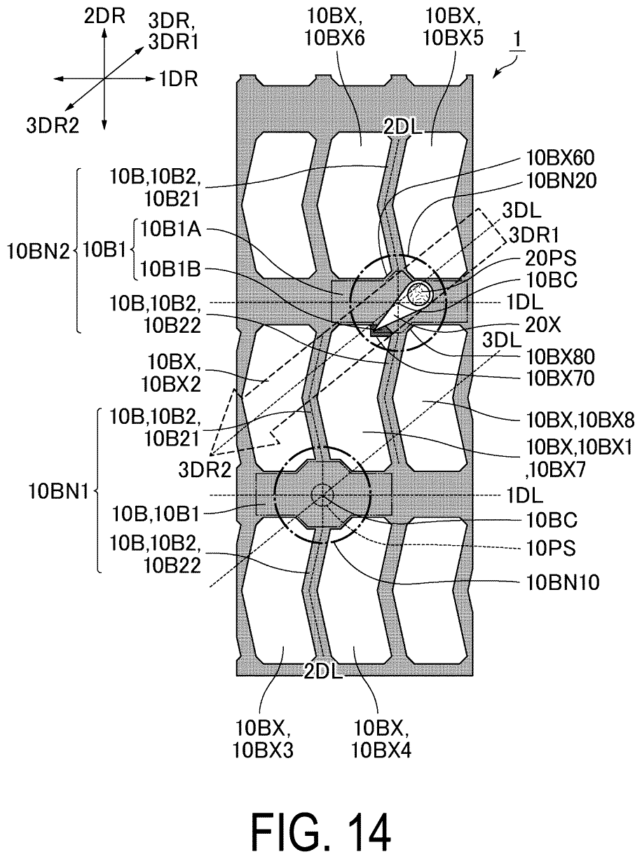

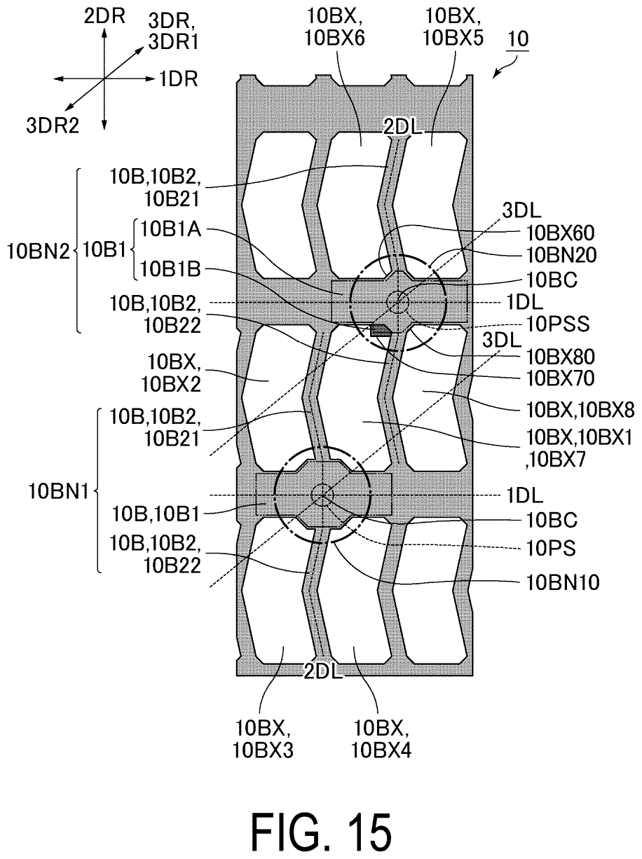

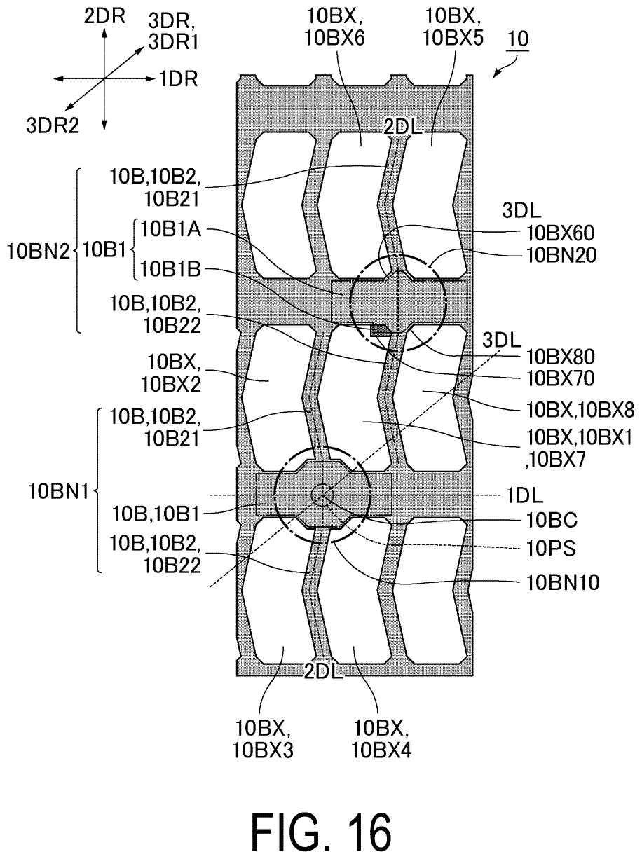

FIG. 14 is a schematic plan view of a display device according to the second embodiment. FIG. 15 and FIG. 16 are each a schematic plan view illustrating an example of a first liquid crystal panel included in the display device according to the second embodiment.

As illustrated in FIGS. 14 to 16, the plurality of openings 10BX further preferably include a fifth opening 10BX5, a sixth opening 10BX6, a seventh opening 10BX7, and an eighth opening 10BX8 arranged in a matrix shape. Further, the black matrix 10B preferably includes a second region 10BN2 different from the first region 10BN1, and is located at the center of the fifth opening 10BX5, the sixth opening 10BX6, the seventh opening 10BX7, and the eighth opening 10BX8. The second region 10BN2 preferably includes a first extending section 10B1 extending in a first direction 1DR, a second extending section 10B2 extending from the first extending section 10B1 toward one side and the other side in a second direction 2DR (a second extending section 10B21 extending toward one side and a second extending section 10B22 extending toward the other side), and a center portion 10BC located at an intersection point between a center line of the first extending section 10B1 and a center line of the second extending section 10B2. The second region 10BN2 of the black matrix 10B of the present embodiment has the same configuration as the first region 10BN1 disclosed in the first embodiment and the modified examples thereof.

In this case, at least one of the fifth opening 10BX5, the sixth opening 10BX6, the seventh opening 10BX7, and the eighth opening 10BX8 is an opening different from the first opening 10BX1, the second opening 10BX2, the third opening 10BX3, and the fourth opening 10BX4. For example, all of the fifth opening 10BX5, sixth opening 10BX6, seventh opening 10BX7, and eighth opening 10BX8 may be different from the first opening 10BX1, second opening 10BX2, third opening 10BX3, and fourth opening 10BX4, any one of the fifth opening 10BX5, sixth opening 10BX6, seventh opening 10BX7, and eighth opening 10BX8 may be the same opening as any one of the first opening 10BX1, second opening 10BX2, third opening 10BX3, and fourth opening 10BX4, or any two of the fifth opening 10BX5, sixth opening 10BX6, seventh opening 10BX7, and eighth opening 10BX8 may be the same openings as any two of the first opening 10BX1, second opening 10BX2, third opening 10BX3, and fourth opening 10BX4.

The fifth opening 10BX5 is located on one side 3DR1 in a third direction 3DR relative to the center portion 10BC of the second region 10BN2, and the seventh opening 10BX7 is located on the other side 3DR2 in the third direction 3DR relative to the center portion 10BC of the second region 10BN2. The fifth opening 10BX5 and the sixth opening 10BX6 are adjacent to each other along the first direction 1DR, and the seventh opening 10BX7 and the eighth opening 10BX8 are adjacent to each other along the first direction 1DR. The sixth opening 10BX6 and the seventh opening 10BX7 are adjacent to each other along the second direction 2DR, and the fifth opening 10BX5 and the eighth opening 10BX8 are adjacent to each other along the second direction 2DR.

The spacer 20PS preferably overlaps at least one of the first region 10BN1 and the second region 10BN2 in a plan view, and the first liquid crystal panel 10 further includes the first liquid crystal panel-side spacer 10PS overlapping at least one of the first region 10BN1 and the second region 10BN2 in the plan view. The tip of the first liquid crystal panel-side spacer 10PS of the present embodiment is in contact with the array substrate 110.

As illustrated in FIG. 14, the alignment film 21 has been subjected to rubbing treatment from the one side 3DR1 toward the other side 3DR2 in the third direction 3DR. Preferably, the spacer 20PS does not overlap the first region 10BN1 but overlaps the second region 10BN2 in a plan view, and is disposed on the one side 3DR1 in the third direction 3DR relative to the center portion 10BC of the second region 10BN2; the first liquid crystal panel-side spacer 10PS preferably overlaps the first extending section 10B1 of the first region 10BN1 and does not overlap the second region 10BN2 in the plan view. With this aspect, the alignment defect region 20X likely to be generated on the other side 3DR2 (the downstream side in the rubbing direction) in the third direction 3DR can be effectively shielded from light, and a decrease in display quality can be effectively suppressed.

The spacer 20PS of the present embodiment preferably overlaps the first extending section 10B1 of the second region 10BN2 of the black matrix 10B in a plan view.

In the first embodiment and the modified examples thereof, the spacer 20PS of the second liquid crystal panel 20 is disposed to substantially overlap a region where the main spacer (the first liquid crystal panel-side spacer 10PS) of the first liquid crystal panel 10 is disposed. Since the area of the black matrix disposed in the periphery of the main spacer is large, the alignment defect region can be shielded from light by effectively utilizing the large area of the light blocking region.

On the other hand, the disposition density of the spacers 10PS of the first liquid crystal panel 10 is not necessarily the same as that of the spacers 20PS of the second liquid crystal panel 20 in some cases. For example, in the case where the first liquid crystal panel 10 includes a plurality of the main spacers (spacers 10PS) and the second liquid crystal panel 20 includes a plurality of the spacers 20PS larger in number than the main spacers (spacers 10PS), the disposition portion of the spacers 20PS is insufficient when the spacers 20PS of the second liquid crystal panel 20 are simply disposed in the disposition portion of the main spacers of the first liquid crystal panel 10. Further, the disposition pitch of the main spacers (spacers 10PS) of the first liquid crystal panel 10 and the disposition pitch of the spacers 20PS of the second liquid crystal panel 20 may be unequal (or may not have an integer multiple relation) in some cases.

In such cases, as in the present embodiment, it is preferable that the tip of the first liquid crystal panel-side spacer 10PS be in contact with the array substrate 110 and overlap the first region 10BN1 of the black matrix 10B in a plan view, and that the second liquid crystal panel-side spacer 20PS overlap the second region 10BN2 of the black matrix 10B in the plan view. That is, it is effective to dispose the spacers 20PS of the second liquid crystal panel 20 in correspondence with a portion other than the portion in which the main spacers (spacers 10PS) of the first liquid crystal panel 10 are disposed. The spacer 20PS of the second liquid crystal panel 20 can be disposed in an intersection region in which the main spacer (spacer 10PS) of the first liquid crystal panel 10 is not disposed or a sub-spacer lower in height than the main spacer is disposed among the intersection regions of the black matrix 10B in a lattice pattern.

For example, as illustrated in FIG. 15, the first liquid crystal panel 10 includes a sub-spacer 10PSS with the tip not in contact with the array substrate 110, and the sub-spacer 10PSS overlaps the second region 10BN2 of the black matrix 10B in a plan view. The sub-spacer 10PSS preferably overlaps the first extending section 10B1 of the second region 10BN2 of the black matrix 10B in the plan view.

As illustrated in FIG. 16, the first liquid crystal panel 10 is allowed not to include any of a main spacer whose tip is in contact with the array substrate 110 and a sub-spacer whose tip is not in contact with the array substrate 110 in a region overlapping the second region 10BN2 of the black matrix 10B.

As illustrated in FIG. 14, it is preferable that the spacer 20PS be disposed in a region located on the one side 3DR1 in the third direction 3DR among two regions of the first extending section 10B1 of the second region 10BN2 divided by a second straight line 2DL in a plan view. With this aspect, the alignment defect region 20X likely to be generated on the other side 3DR2 (the downstream side in the rubbing direction) in the third direction 3DR can be effectively shielded from light, and a decrease in display quality can be effectively suppressed.

As illustrated in FIG. 14, the spacer 20PS preferably overlaps a third straight line 3DL passing through the center portion 10BC of the second region 10BN2 and being parallel to the third direction 3DR in a plan view. With the above aspect, the alignment defect region 20X likely to be generated on the other side 3DR2 (downstream side in the rubbing direction) in the third direction 3DR can be more effectively shielded from light, and a decrease in display quality can be more effectively suppressed.

### First Modified Example of Second Embodiment

The spacer 20PS of the present modified example is disposed inside the first extending section 10B1 of the second region 10BN2 and on the one side 3DR1 in the third direction 3DR relative to the center portion 10BC of the second region 10BN2 in a plan view, as in the second embodiment discussed above. Further, the spacer 20PS overlaps the third straight line 3DL passing through the center portion 10BC of the second region 10BN2 and being parallel to the third direction 3DR in the plan view.

When the spacer 20PS of the second liquid crystal panel 20 is disposed corresponding to a portion other than the portion where the main spacer (spacer 10PS) of the first liquid crystal panel 10 is disposed, there is a case in which the area of the black matrix 10B for shielding the alignment defect region 20X from light is insufficient. Accordingly, for example, as in the first modified example of the first embodiment illustrated in FIG. 11, the second region 10BN2 of the black matrix 10B preferably includes a widened width portion 10B1B.

As illustrated in FIG. 14, the second region 10BN2 preferably includes a second intersection region 10BN20 surrounded by the fifth opening 10BX5, the sixth opening 10BX6, the seventh opening 10BX7, and the eighth opening 10BX8, where the first extending section 10B1 of the second region 10BN2 and the second extending section 10B2 of the second region 10BN2 intersect with each other. The second intersection region 10BN20 preferably includes the widened width portion 10B1B of the black matrix widened toward the other side 3DR2 in the third direction 3DR in a region adjacent to a corner 10BX70 of the seventh opening 10BX7 in such a manner that a length from the center portion 10BC of the second region 10BN2 to the corner 10BX70 of the seventh opening 10BX7 adjacent to the second intersection region 10BN20 is longer than a length from the center portion 10BC of the second region 10BN2 to a corner 10BX60 of the sixth opening 10BX6 adjacent to the second intersection region 10BN20. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

Similar to FIG. 10, on the third straight line 3DL, the width 32W of the black matrix 10B from the center portion 10BC of the second region 10BN2 toward the other side 3DR2 in the third direction 3DR is wider than the width 31W of the black matrix 10B from the center portion 10BC of the second region 10BN2 toward the one side 3DR1 in the third direction 3DR. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

As illustrated in FIG. 14, the first extending section 10B1 of the second region 10BN2 preferably includes a symmetrical portion 10B1A having a symmetrical shape with respect to a first straight line 1DL, and the widened width portion 10B1B widened relative to the symmetrical portion 10B1A in a region located on the other side 3DR2 in the third direction 3DR of the two regions of the first extending section 10B1 divided by the second straight line 2DL. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

As illustrated in FIG. 14, when the fifth opening 10BX5 is rotated about the center portion 10BC of the second region 10BN2 to overlap the seventh opening 10BX7 in a plan view, the shape of the corner of the seventh opening 10BX7 on the center portion 10BC side of the second region 10BN2 preferably matches a shape obtained by combining the shape of the corner of the fifth opening 10BX5 on the center portion 10BC side of the second region 10BN2 with the widened width portion 10B1B of the black matrix 10B disposed on the center portion 10BC side of the second region 10BN2 of the seventh opening 10BX7. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

### Second Modified Example of Second Embodiment

The spacer 20PS of the present modified example is disposed inside the first extending section 10B1 of the second region 10BN2 and on the one side 3DR1 in the third direction 3DR relative to the center portion 10BC of the second region 10BN2 in a plan view, as in the second embodiment discussed above. Further, the spacer 20PS does not overlap the third straight line 3DL passing through the center portion 10BC of the second region 10BN2 and being parallel to the third direction 3DR in the plan view.

When the spacer 20PS of the second liquid crystal panel 20 is disposed corresponding to a portion other than the portion where the main spacer (spacer 10PS) of the first liquid crystal panel 10 is disposed, there is a case in which the area of the black matrix 10B for shielding the alignment defect region 20X from light is insufficient. Accordingly, for example, as in the second modified example of the first embodiment illustrated in FIG. 13, the second region 10BN2 of the black matrix 10B preferably includes a widened width portion 10B1C.

As in the second modified example of the first embodiment illustrated in FIG. 13, the second region 10BN2 preferably includes the second intersection region 10BN20 surrounded by the fifth opening 10BX5, the sixth opening 10BX6, the seventh opening 10BX7, and the eighth opening 10BX8, where the first extending section 10B1 of the second region 10BN2 and the second extending section 10B2 of the second region 10BN2 intersect with each other. It is preferable that a corner 10BX80 of the eight opening 10BX8 adjacent to the second intersection region 10BN20 linearly extend along the third direction 3DR from the one side 3DR1 toward the other side 3DR2. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

As in the second modified example of the first embodiment illustrated in FIG. 13, the first extending section 10B1 of the second region 10BN2 preferably includes the symmetrical portion 10B1A having a symmetrical shape with respect to the first straight line 1DL, and the widened width portion 10B1C widened relative to the symmetrical portion 10B1A in a region located on the one side 3DR1 in the third direction 3DR of the two regions of the first extending section 10B1 divided by the second straight line 2DL. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

As in the second modified example of the first embodiment illustrated in FIG. 13, when the sixth opening 10BX6 is rotated about the center portion 10BC of the second region 10BN2 to overlap the eighth opening 10BX8 in a plan view, the shape of the corner of the eighth opening 10BX8 on the center portion 10BC side of the second region 10BN2 preferably matches a shape obtained by combining the shape of the corner of the sixth opening 10BX6 on the center portion 10BC side of the second region 10BN2 with the widened width portion 10B1C of the black matrix 10B disposed on the center portion 10BC side of the second region 10BN2 of the eighth opening 10BX8. With this aspect, the alignment defect region 20X likely to be generated on the other side 3DR2 (the downstream side in the rubbing direction) in the third direction 3DR can be more effectively shielded from light, and a decrease in display quality can be more effectively suppressed.

### Third Modified Example of Second Embodiment

The second liquid crystal panel 20 of the present modified example includes the plurality of spacers 20PS and a plurality of the second regions 10BN2. Each spacer 20PS overlaps with the corresponding second region 10BN2 in a plan view. The second intersection region 10BN20 included in some of the second regions 10BN2 includes the widened width portion 10B1B of the black matrix 10B widened toward the other side 3DR2 in the third direction 3DR in a region adjacent to the corner 10BX70 of the seventh opening 10BX7. The corner 10BX80 of the eighth opening 10BX8 adjacent to other second regions 10BN2 linearly extends along the third direction 3DR from the one side 3DR1 toward the other side 3DR2. As described above, the configuration of the first modified example of the second embodiment may be employed in a certain region in the display region 1AA, and the configuration of the second modified example of the second embodiment may be employed in another region.

### Third Embodiment

In the present embodiment, features unique to the present embodiment will be mainly described, and description of contents overlapping with those of the first embodiment and its modified examples as well as the second embodiment and its modified examples will be omitted. A second liquid crystal panel 20 provided in a display device 1 of the present embodiment includes both the spacer 20PS disclosed in the first embodiment and its modified examples, and the spacer 20PS disclosed in the second embodiment and its modified examples.

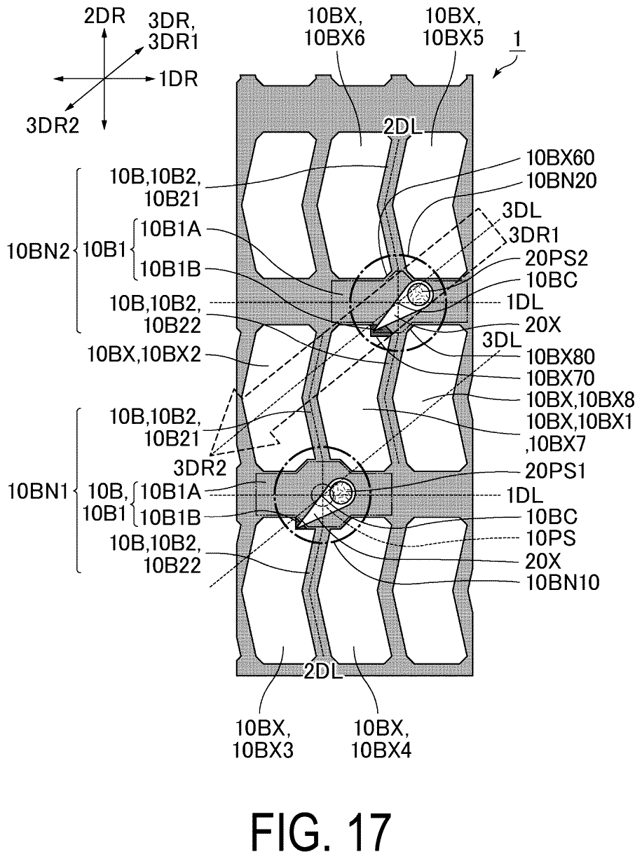

FIG. 17 is a schematic plan view of the display device according to the third embodiment. As illustrated in FIG. 17, the second liquid crystal panel 20 provided in the display device 1 of the present embodiment includes a first spacer 20PS1 and a second spacer 20PS2. The first spacer 20PS1 corresponds to the spacer 20PS in the first embodiment and the modified examples thereof. The second spacer 20PS2 corresponds to the spacer 20PS in the second embodiment and the modified examples thereof. As described above, it is also possible to combine the spacer 20PS in the first embodiment and the modified examples thereof with the spacer 20PS in the second embodiment.

### Fourth Embodiment

In the present embodiment, features unique to the present embodiment will be mainly described, and description of contents overlapping with those of the first embodiment and its modified examples, the second embodiment, and the third embodiment will be omitted. A second liquid crystal panel 20 provided in a display device 1 of the present embodiment further includes a light blocking layer.

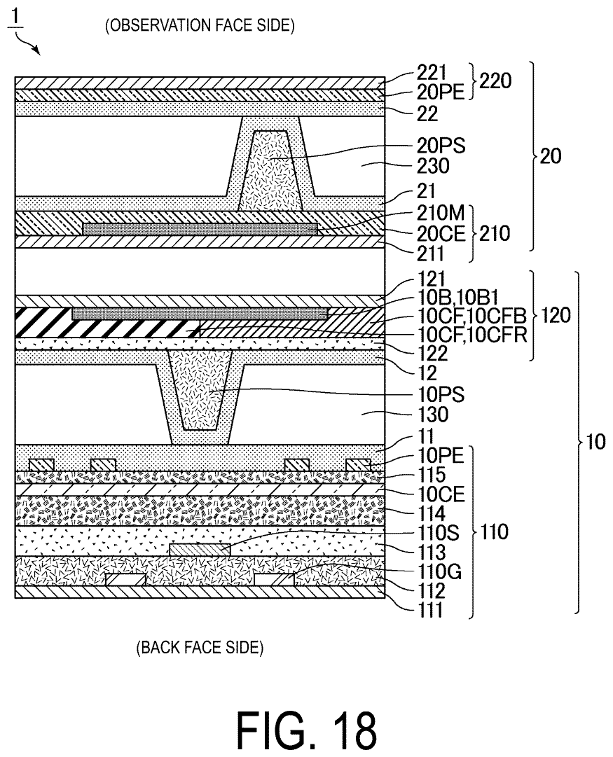

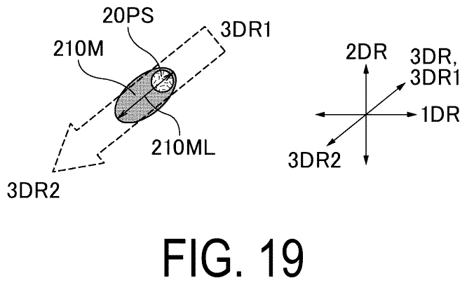

FIG. 18 is a schematic cross-sectional view of the display device according to the fourth embodiment. FIGS. 19 to 21 are each a schematic plan view illustrating an example of a light blocking body and a spacer included in the second liquid crystal panel according to the display device of the fourth embodiment. As illustrated in FIGS. 18 to 21, the second liquid crystal panel 20 of the present embodiment further includes a light blocking body 210M overlapping at least part of the spacer 20PS in a plan view. With the above aspect, an alignment defect region 20X in the periphery of the spacer 20PS can be effectively shielded from light, and a decrease in display quality can be effectively suppressed.

In a plan view, the alignment defect region 20X caused by the spacer 20PS is preferably disposed inside the light blocking body 210M. With the above aspect, the alignment defect region 20X can be more effectively shielded from light by the light blocking body 210M, and a decrease in display quality can be effectively suppressed.

In a plan view, preferably, a part of a region of the alignment defect region 20X caused by the spacer 20PS overlaps the black matrix 10B but does not overlap the light blocking body 210M, and another part of the region of the alignment defect region 20X does not overlap the black matrix 10B but overlaps the light blocking body 210M. With such aspect, the alignment defect region 20X can be effectively shielded from light while suppressing a range in which the light blocking body 210M is disposed, and a decrease in display quality can be effectively suppressed.

The display device 1 of the present embodiment includes a first substrate 210 and a second substrate 220 in order from the back face side toward the observation face side. The first substrate 210 includes a support substrate 211, the light blocking body 210M, a first substrate-side electrode 20CE, and an alignment film 21 in order toward a side of a liquid crystal layer 230. The alignment film 21 has been subjected to alignment treatment in a third direction 3DR different from a first direction 1DR and a second direction 2DR in a plan view. In the present embodiment, the first substrate-side electrode 20CE functions as a segment electrode, and a second substrate-side electrode 20PE functions as a common electrode.

The light blocking body 210M preferably has a higher light blocking property. For example, a metal material having a light blocking property can be used, but the material is not particularly limited as long as it has a light blocking function. In a case where a resin material is used as the light blocking body 210M, for example, a resin material having at least one of the following optical characteristics may be used: an OD value, which is an index of the degree of light absorption, is in a range from 3 to 6, and light reflectivity is in a range from 18 to 108. It is preferable for the OD value of the light blocking body 210M to be higher, more preferable to be 3.5 or more, and further more preferable to be 4 or more. It is preferable for the light reflectivity of the light blocking body 210M to be lower, more preferable to be 8% or less, further more preferable to be 7% or less, and still more preferable to be 6% or less.

The OD value (OD(λ)) at a measurement wavelength λ can be determined by an equation given below. The measurement wavelength λ is, for example, a wavelength in the visible light range (specifically, for example, λ=430±5 nm for blue light, λ=535±5 nm for green light, and λ=625+5 nm for red light). The OD value can be measured by a Macbeth density measurement method using TD-904 manufactured by Kollmorgen Corp.

$$OD ( λ ) = Log 10 [ T ( λ ) / I ( λ ) ] = Log 10 T ( λ ) - Log 10 I ( λ )$$

In the equation, λ represents a measurement wavelength, T(λ) represents an amount of transmitted light at the measurement wavelength, and I(λ) represents an amount of incident light at the measurement wavelength.

The light reflectivity can be measured with a spectrophotometer (CM-2002 manufactured by Minolta Co., Ltd.) while taking luminous reflectance (Y) as an index.

In order not to increase the number of manufacturing steps, the light blocking body 210M is preferably formed in the same layer as a metal layer used for terminals, wiring lines, and marks for applying signals to the transparent electrode (first substrate-side electrode 20CE) included in the second liquid crystal panel 20.

In general, a positional deviation (for example, about ±5 μm) at the time of bonding two substrates constituting a liquid crystal panel is larger than a positional deviation (for example, about ±1 μm) at the time of patterning in different layers in one substrate. Therefore, it is preferable to form the spacer 20PS and the light blocking body 210M in the same substrate in order to suppress a situation in which the light blocking body 210M becomes larger than necessary in consideration of the positional deviation. That is, the light blocking body 210M is preferably included in the first substrate 210.

As illustrated in FIG. 18, the light blocking body 210M is preferably disposed inside a black matrix 10B, and more preferably disposed inside a first extending section 10B1 of the black matrix 10B in a plan view. With the above aspect, the alignment defect region 20X in the periphery of the spacer 20PS can be effectively shielded from light, and a decrease in display quality can be effectively suppressed while suppressing a reduction in aperture ratio.

As illustrated in FIGS. 19 to 21, the light blocking body 210M has a floating island shape in a plan view.

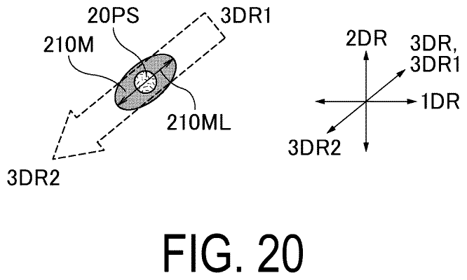

As illustrated in FIGS. 19 and 20, in a plan view, the light blocking body 210M has a longitudinal floating island shape, and a longitudinal direction 210ML of the light blocking body 210M is parallel to a third direction 3DR. With the above aspect, the alignment defect region 20X in the periphery of the spacer 20PS can be effectively shielded from light, and a decrease in display quality can be effectively suppressed.

As illustrated in FIG. 19, in a plan view, the spacer 20PS is disposed closer to one side 3DR1 in the third direction 3DR than the center in the longitudinal direction 210ML of the light blocking body 210M. With this aspect, the alignment defect region 20X in the periphery of the spacer 20PS can be more effectively shielded from light, and a decrease in display quality can be more effectively suppressed.

As illustrated in FIG. 20, in a plan view, the spacer 20PS overlaps the center in the longitudinal direction 210ML of the light blocking body 210M. With this aspect, the alignment defect region 20X in the periphery of the spacer 20PS can be more effectively shielded from light, and a decrease in display quality can be more effectively suppressed.

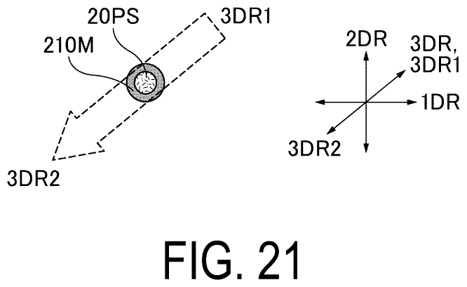

As illustrated in FIG. 21, in a plan view, the light blocking body 210M has a circular floating island shape, and the spacer 20PS is disposed at the center of the light blocking body 210M. With the above aspect, the alignment defect region 20X in the periphery of the spacer 20PS can be effectively shielded from light, and a decrease in display quality can be effectively suppressed. In this case, the spacer 20PS being disposed at the center of the light blocking body 210M means that the spacer 20PS overlaps the center of the light blocking body 210M in the plan view.

The effects of the disclosure will be described below with reference to Examples, but the disclosure is not limited by Examples given below.

### Example 1

The present example is a display device 1 corresponding to the first embodiment. In the display device 1 of the present example, the black matrix 10B included in the first liquid crystal panel 10 can shield, from light, a region (alignment defect region 20X) where liquid crystal alignment is disordered in the second liquid crystal panel 20, thereby making it unnecessary to provide a light blocking body (also referred to as a light blocking layer) in the second liquid crystal panel 20. As a result, it is possible to suppress the degradation in display quality while suppressing a reduction in transmittance (aperture ratio) and a variation in thickness of the second liquid crystal panel 20.

### Example 2

The present example is a display device 1 corresponding to the first modified example of the first embodiment. In the display device 1 of the present example, since the alignment defect region 20X likely to be generated on the other side 3DR2 (downstream side in the rubbing direction) in the third direction 3DR can be more effectively shielded from light, a decrease in display quality can be more effectively suppressed while suppressing a reduction in transmittance (aperture ratio) and a variation in thickness of the second liquid crystal panel 20.

### Example 3

The present example is a display device 1 corresponding to the second modified example of the first embodiment. In the display device 1 of the present example, since the alignment defect region 20X likely to be generated on the other side 3DR2 (downstream side in the rubbing direction) in the third direction 3DR can be more effectively shielded from light, a decrease in display quality can be more effectively suppressed while suppressing a reduction in transmittance (aperture ratio) and a variation in thickness of the second liquid crystal panel 20.

### Example 4

The present example is a display device 1 corresponding to the second embodiment. The display device 1 of the present example can suppress the degradation in display quality while suppressing a reduction in transmittance (aperture ratio) and a variation in thickness of the second liquid crystal panel 20.

### Example 5

The present example is a display device 1 corresponding to the first modified example of the second embodiment. In the display device 1 of the present example, since the alignment defect region 20X likely to be generated on the other side 3DR2 (downstream side in the rubbing direction) in the third direction 3DR can be more effectively shielded from light, a decrease in display quality can be more effectively suppressed while suppressing a reduction in transmittance (aperture ratio) and a variation in thickness of the second liquid crystal panel 20.

### Example 6

The present example is a display device 1 corresponding to the second modified example of the second embodiment. In the display device 1 of the present example, since the alignment defect region 20X likely to be generated on the other side 3DR2 (downstream side in the rubbing direction) in the third direction 3DR can be more effectively shielded from light, a decrease in display quality can be more effectively suppressed while suppressing a reduction in transmittance (aperture ratio) and a variation in thickness of the second liquid crystal panel 20.

### Example 7

The present example is a display device 1 corresponding to the third embodiment. More specifically, the display device 1 of the present example includes at least one of the spacers 20PS of the first and second modified examples of the first embodiment, and at least one of the spacers 20PS of the first and second modified examples of the second embodiment. The display device 1 of the present example can suppress the degradation in display quality while suppressing a reduction in transmittance (aperture ratio) and a variation in thickness of the second liquid crystal panel 20.

### Example 8

The present example is a display device 1 corresponding to the fourth embodiment. The display device 1 of the example can more effectively suppress the degradation in display quality.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A display device, comprising:
a display region in which an image is displayed, and a frame region provided around the display region; and
a first liquid crystal panel and a second liquid crystal panel provided to oppose the first liquid crystal panel,
wherein the first liquid crystal panel includes a plurality of pixel electrodes disposed in a matrix shape along a first direction and a second direction intersecting with the first direction in a plan view, and a black matrix extended in the first direction and the second direction and provided with a plurality of openings that overlap the plurality of pixel electrodes,
the second liquid crystal panel sequentially includes a first substrate, a spacer overlapping the display region in the plan view, an alignment film having been subjected to alignment treatment in a third direction different from the first and second directions in the plan view, a liquid crystal layer, and a second substrate, and
the spacer overlaps the black matrix in the plan view.

2. The display device according to claim 1,
wherein the plurality of openings include a first opening, a second opening, a third opening, and a fourth opening arranged in a matrix shape,
the black matrix includes a first region located at a center of the first opening, the second opening, the third opening, and the fourth opening, and
the first region includes a first extending section extending in the first direction, a second extending section extending from the first extending section toward one side and the other side in the second direction, and a center portion located at an intersection point between a center line of the first extending section and a center line of the second extending section.

3. The display device according to claim 2,
wherein the alignment film is subjected to rubbing treatment from one side toward the other side in the third direction, and
the spacer is disposed inside the first extending section of the first region and on the one side in the third direction relative to the center portion of the first region in a plan view.

4. The display device according to claim 3,
wherein the first opening is located on the one side in the third direction relative to the center portion of the first region,
the third opening is located on the other side in the third direction relative to the center portion of the first region,
the first and second openings are adjacent to each other along the first direction,
the third and fourth openings are adjacent to each other along the first direction,
the first region includes a first intersection region in which the first and second extending sections intersect each other and that is surrounded by the first, second, third, and fourth openings, and
the first intersection region includes a widened width portion of the black matrix widened toward the other side in the third direction in a region adjacent to a corner of the third opening in such a manner that a length from the center portion of the first region to the corner of the third opening adjacent to the first intersection region is longer than a length from the center portion of the first region to a corner of the second opening adjacent to the first intersection region.

5. The display device according to claim 3,
wherein the first opening is located on the one side in the third direction relative to the center portion of the first region,
the third opening is located on the other side in the third direction relative to the center portion of the first region,
the first and second openings are adjacent to each other along the first direction,
the third and fourth openings are adjacent to each other along the first direction,
the first region includes a first intersection region in which the first and second extending sections intersect each other and that is surrounded by the first, second, third, and fourth openings, and
a corner of the fourth opening adjacent to the first intersection region linearly extends along the third direction from the one side toward the other side.

6. The display device according to claim 2,
wherein the first liquid crystal panel further includes a first liquid crystal panel-side spacer overlapping the first extending section of the first region in a plan view.

7. The display device according to claim 2,
wherein the plurality of openings further include a fifth opening, a sixth opening, a seventh opening, and an eighth opening arranged in a matrix shape,
the black matrix further includes a second region different from the first region located at a center of the fifth opening, the sixth opening, the seventh opening, and the eighth opening,
the second region includes a first extending section extending in the first direction, a second extending section extending from the first extending section toward the one side and the other side in the second direction, and a center portion located at an intersection point between a center line of the first extending section and a center line of the second extending section,
the spacer overlaps at least one of the first region and the second region in a plan view, and
the first liquid crystal panel further includes a first liquid crystal panel-side spacer overlapping at least one of the first region and the second region in the plan view.

8. The display device according to claim 7,
wherein the alignment film is subjected to rubbing treatment from one side toward the other side in the third direction,
the spacer does not overlap the first region but overlaps the second region in a plan view, and is disposed on the one side in the third direction relative to the center portion of the second region, and
the first liquid crystal panel-side spacer overlaps the first extending section of the first region but does not overlap the second region in the plan view.

9. The display device according to claim 8,
wherein the fifth opening is located on the one side in the third direction relative to the center portion of the second region,
the seventh opening is located on the other side in the third direction relative to the center portion of the second region,
the fifth and sixth openings are adjacent to each other along the first direction,
the seventh and eighth openings are adjacent to each other along the first direction,
the second region includes a second intersection region in which the first and second extending sections of the second region intersect each other and that is surrounded by the fifth, sixth, seventh, and eighth openings, and
the second intersection region includes a widened width portion of the black matrix widened toward the other side in the third direction in a region adjacent to a corner of the seventh opening in such a manner that a length from the center portion of the second region to the corner of the seventh opening adjacent to the second intersection region is longer than a length from the center portion of the second region to a corner of the sixth opening adjacent to the second intersection region.

10. The display device according to claim 8,
wherein the fifth opening is located on the one side in the third direction relative to the center portion of the second region,
the seventh opening is located on the other side in the third direction relative to the center portion of the second region,
the fifth and sixth openings are adjacent to each other along the first direction,
the seventh and eighth openings are adjacent to each other along the first direction,
the second region includes a second intersection region in which the first and second extending sections of the second region intersect each other and that is surrounded by the fifth, sixth, seventh, and eighth openings, and
a corner of the eighth opening adjacent to the second intersection region linearly extends along the third direction from the one side toward the other side.

11. The display device according to claim 1,
wherein the second liquid crystal panel further includes a light blocking body overlapping at least part of the spacer in a plan view.

12. The display device according to claim 11,
wherein the alignment film is subjected to rubbing treatment from the one side toward the other side in the third direction,
the light blocking body has a longitudinal floating island shape in a plan view,
a longitudinal direction of the light blocking body is parallel to the third direction in the plan view, and
the spacer is disposed on the one side in the third direction relative to a center in the longitudinal direction of the light blocking body in the plan view.

13. The display device according to claim 11,
wherein the alignment film is subjected to rubbing treatment from the one side toward the other side in the third direction,
the light blocking body has a longitudinal floating island shape in a plan view,
a longitudinal direction of the light blocking body is parallel to the third direction in the plan view, and
the spacer overlaps a center in the longitudinal direction of the light blocking body in the plan view.

14. The display device according to claim 11,
wherein the light blocking body has a circular floating island shape in a plan view, and
the spacer is disposed at a center of the light blocking body in the plan view.

15. The display device according to claim 1,
wherein the second liquid crystal panel includes a plurality of the spacers, and
at least one of (A) and (B) given below is satisfied.
(A) A pitch of the plurality of spacers in the first direction is an integer multiple of a pitch of the plurality of pixel electrodes in the first direction.
(B) A pitch of the plurality of spacers in the second direction is an integer multiple of a pitch of the plurality of pixel electrodes in the second direction.
